(19) United States
(12) Patent Application Publication
(10) Pub. No.: US 2022/0058998 A1
(43) Pub. Date: Feb. 24, 2022

(54) DISPLAY CONTROL DEVICE AND NON-TRANSITORY COMPUTER-READABLE STORAGE MEDIUM FOR DISPLAY CONTROL ON HEAD-UP DISPLAY

(71) Applicant: DENSO CORPORATION, Kariya-city (JP)

(72) Inventors: Akihiko Yagyu, Kariya-city (JP); Daisuke Takemori, Kariya-city (JP); Yasuhiro Shimizu, Kariya-city (JP); Kazuki Kojima, Kariya-city (JP); Shiori Maneyama, Kariya-city (JP)

(21) Appl. No.: 17/453,363

(22) Filed: Nov. 3, 2021

Related U.S. Application Data
(63) Continuation of application No. PCT/JP2020/012624, filed on Mar. 23, 2020.

(30) Foreign Application Priority Data
May 8, 2019 (JP) 2019-088608
Feb. 20, 2020 (JP) 2020-026955

(51) Int. Cl. G09G 3/00; G06K 9/00; G06T 7/70; B60K 35/00

(52) U.S. Cl. CPC G09G 3/002; G06K 9/00798; G06T 7/70; B60K 35/00; B60K 2370/166; G09G 2380/10; G06T 2207/30256; B60K 2370/1529; G09G 2360/04

(57) ABSTRACT

In a display control device for a head-up display in a vehicle, a boundary information regarding a boundary of a travel lane recognized for driving control of the vehicle is acquired, and guidance information used for route guidance is acquired. When an estimated trajectory content indicating an estimated trajectory of the vehicle controlled based on the boundary information and a route guidance content providing guidance on a route at a predetermined point based on the guidance information are displayed together, the estimated trajectory content and the route guidance content are displayed in different modes from each other, or a display range of the estimated trajectory content is limited to a range not beyond a predetermined point for the route guidance. As another example, when the guidance information is acquired during display of the estimated trajectory content, the route guidance content is displayed while hiding the estimated trajectory content.

### CROSS REFERENCE TO RELATED APPLICATIONS

The present application is a continuation application of International Patent Application No. PCT/JP2020/012624 filed on Mar. 23, 2020, which designated the U.S. and claims the benefit of priority from Japanese Patent Application No. 2019-088608 filed on May 8, 2019 and Japanese Patent Application No. 2020-026955 filed on Feb. 20, 2020. The entire disclosures of all of the above applications are incorporated herein by reference.

### TECHNICAL FIELD

The present disclosure relates to a display control device and a non-transitory computer-readable storage medium to control display on a head-up display.

### BACKGROUND

For example, there is a travel control device that automatically generates a trajectory of a lane change and automatically guides a subject vehicle to a destination of the lane change according to the generated trajectory. Such a travel control device causes an instrument such as a meter and a navigation device to superimpose a guidance display of the lane change based on the automatic guidance on a captured real image of a foreground of the subject vehicle. As the instrument, for example, a head-up display may be employed.

### SUMMARY

The present disclosure describes a display control device and a non-transitory computer-readable storage medium for a vehicle to control display on a head-up display to present an estimated trajectory content indicating an estimated trajectory of the vehicle and a route guidance content providing guidance on a route at a predetermined point in an easy-to-understand manner.

### BRIEF DESCRIPTION OF DRAWINGS

FIG. 1 is a diagram illustrating an overview of an in-vehicle network including a HCU according to a first embodiment of the present disclosure.

FIG. 2 is a diagram illustrating a head-up display mounted on a vehicle.

FIG. 3 is a diagram illustrating a schematic configuration of the HCU.

FIG. 4 is a diagram visually illustrating simulation of a display layout provided by a display generation unit.

FIG. 5 is a time chart illustrating a display transition when guidance information is acquired during display of an estimated trajectory content, but the vehicle is travelled without following a route guidance.

FIG. 6 is a time chart illustrating a display transition when guidance information is acquired during display of an estimated trajectory content and the vehicle is travelled following a route guidance.

FIG. 7 is a diagram illustrating an estimated trajectory display.

FIG. 8 is a diagram illustrating a route announcement display.

FIG. 9 is a diagram illustrating another display example of the route announcement display.

FIG. 10 is a diagram illustrating a route leading display.

FIG. 11 is a diagram illustrating a point passage display.

FIG. 12 is a diagram illustrating a lane change (LC) execution display.

FIG. 13 is a diagram illustrating an estimated trajectory display after a lane change.

FIG. 14 is a flowchart for illustrating details of a display control process that realizes a display control method of the first embodiment together with FIG. 15.

FIG. 15 is a flowchart for illustrating details of the display control process together with FIG. 14.

FIG. 16 is a diagram illustrating an estimated trajectory display according to a second embodiment.

FIG. 17 is a diagram illustrating a route announcement display.

FIG. 18 is a diagram illustrating a route leading display.

FIG. 19 is a diagram illustrating a point passage display.

FIG. 20 is a diagram illustrating a route announcement display according to a third embodiment.

FIG. 21 is a diagram illustrating a route leading display.

FIG. 22 is a diagram illustrating a point passage display.

FIG. 23 is a diagram illustrating a route announcement display according to a fourth embodiment.

FIG. 24 is a diagram illustrating a route leading display.

FIG. 25 is a diagram illustrating a point passage display.

FIG. 26 is a diagram illustrating a route leading display at an intersection according to a fifth embodiment.

FIG. 27 is a diagram illustrating a route leading display at a branch point.

FIG. 28 is a time chart illustrating a display transition when a vehicle travelled without following a route guidance.

FIG. 29 is a time chart illustrating a display transition when the vehicle is travelled following the route guidance.

FIG. 30 is a diagram illustrating a route notice display.

FIG. 31 is a diagram illustrating a route leading display.

FIG. 32 is a diagram illustrating a point passage display.

FIG. 33 is a diagram illustrating a lane change (LC) execution display.

FIG. 34 is a diagram illustrating an estimated trajectory display after a lane change.

FIG. 35 is a diagram illustrating a route leading display of a second modification.

FIG. 36 is a diagram illustrating a route leading display of a third modification.

FIG. 37 is a diagram illustrating a route leading display of a fourth modification.

FIG. 38 is a diagram illustrating a route leading display of a fifth modification.

FIG. 39 is a diagram illustrating a route leading display of a sixth modification.

FIG. 40 is a diagram illustrating a route leading display of a seventh modification.

FIG. 41 is a diagram illustrating a route leading display of an eighth modification.

FIG. 42 is a diagram illustrating a route leading display of a ninth modification.

FIG. 43 is a diagram illustrating a route leading display of a tenth modification.

FIG. 44 is a diagram illustrating a route leading display of an eleventh modification.

FIG. 45 is a diagram illustrating a route leading display of a twelfth modification.

FIG. 46 is a diagram illustrating a route leading display of a thirteenth modification.

FIG. 47 is a diagram illustrating a route leading display of a fourteenth modification.

FIG. 48 is a diagram illustrating a route leading display and an LC execution display of a fifteenth modification.

### DETAILED DESCRIPTION

For example, a head-up display may be used not only to display a content related to driving control such as a lane change guidance display, but also to display a content related to route guidance in a vehicle equipped with a navigation device. However, if the content related to the driving control and the content related to route guidance are simply displayed side by side, such displays are likely to be difficult for the user to understand.

The present disclosure provides a display control device, a display control program, and a non-transitory computer-readable storage medium having instructions, which are capable of displaying a plurality of contents in an easy-to-understand manner.

According to an aspect of the present disclosure, a display control device is used for a vehicle to control display on a head-up display, and includes: a boundary information acquisition unit that acquires a boundary information related to a boundary of a travel lane recognized by a driving control of the vehicle; a guidance information acquisition unit that acquires guidance information used for a route guidance; and a display control unit that displays an estimated trajectory content indicating an estimated trajectory of the vehicle, a driving of which is controlled based on the boundary information, to be superimposed on a road surface, and displays a route guidance content for providing guidance on a route at a predetermined point based on the guidance information. When displaying the estimated trajectory content and the route guidance content together, the display control unit causes the estimated trajectory content and the route guidance content to be displayed in different modes from each other.

According to an aspect of the present disclosure, a display control program is used for a vehicle to control display on a head-up display, and causes one or more processors to perform a process including: acquiring boundary information related to a boundary of a travel lane recognized for a driving control of the vehicle; displaying an estimated trajectory content indicating an estimated trajectory of the vehicle, a driving of which is controlled based on the boundary information, to be superimposed on a road surface; acquiring guidance information used for a route guidance; and displaying a route guidance content for providing guidance on a route at a predetermined position based on the guidance information, in which when displaying the estimated trajectory content and the route guidance content together, the estimated trajectory content and the route guidance content are displayed in modes different from each other.

According to an aspect of the present disclosure, a non-transitory computer-readable storage medium stores program instructions for controlling a head-up display of a vehicle. The program instructions causes one or more processors to: acquire boundary information related to a boundary of a travel lane recognized for a driving control of the vehicle; display an estimated trajectory content indicating an estimated trajectory of the vehicle, a driving of which is controlled based on the boundary information, to be superimposed on a road surface; acquire guidance information used for a route guidance; and display a route guidance content for providing guidance on a route at a predetermined position based on the guidance information, in which when the estimated trajectory content and the route guidance content are displayed together, the estimated trajectory content and the route guidance content are displayed in modes different from each other.

According to such aspects, the estimated trajectory content and the route guidance content are displayed in different modes from each other, when being displayed together. Therefore, for example, in a scene where the vehicle reaches a predetermined point and the route guidance is performed under the driving control of the vehicle, even if the estimated trajectory content and the route guidance content are combined on the display, the individual contents can be distinguished by a user. Therefore, it is possible to display a plurality of contents in an easy-to-understand manner.

According to an aspect of the present disclosure, a display control device is used for a vehicle to control display on a head-up display, includes: a boundary information acquisition unit that acquires a boundary information related to a boundary of a travel lane recognized by a driving control of the vehicle; a guidance information acquisition unit that acquires guidance information used for a route guidance; and a display control unit that displays an estimated trajectory content indicating an estimated trajectory of the vehicle, a driving of which is controlled based on the boundary information, to be superimposed on a road surface, and displays a route guidance content for providing guidance on a route at a predetermined point based on the guidance information. When displaying both the estimated trajectory content and the route guidance content, the display control unit limits display of the estimated trajectory content to a range not beyond the predetermined point.

According to an aspect of the present disclosure, a display control program is used for a vehicle to control display on a head-up display, and causes one or more processors to perform a process including: acquiring boundary information related to a boundary of a travel lane recognized for a driving control of the vehicle; displaying an estimated trajectory content indicating an estimated trajectory of the vehicle, a driving of which is controlled based on the boundary information, to be superimposed on a road surface; acquiring guidance information used for a route guidance; and displaying a route guidance content for providing guidance on a route at a predetermined point based on the guidance information, in which when displaying both the estimated trajectory content and the route guidance content, display of the estimated trajectory content is limited to a range not beyond the predetermined point.

According to an aspect of the present disclosure, a non-transitory computer-readable storage medium stores program instructions for controlling a head-up display of a vehicle. The program instructions causes one or more processors to: acquire boundary information related to a boundary of a travel lane recognized for a driving control of the vehicle; display an estimated trajectory content indicating an estimated trajectory of the vehicle, a driving of which is controlled based on the boundary information, to be superimposed on a road surface; acquire guidance information used for a route guidance; and display a route guidance content for providing guidance on a route at a predetermined point based on the guidance information, in which when displaying both the estimated trajectory content and the route guidance content, display of the estimated trajectory content is limited to a range not beyond the predetermined point.

According to such aspects, the display of the estimated trajectory content is limited to a range not beyond the predetermined point, that is, to a range closer to the user than the predetermined point, when the estimated trajectory content and the route guidance content are displayed together. Therefore, even if the estimated trajectory content and the route guidance content are combined on the display, the individual contents can be distinguished by the user. Therefore, it is possible to display a plurality of contents in an easy-to-understand manner.

According to an aspect of the present disclosure, a display control device is used for a vehicle to control display on a head-up display, and includes: a boundary information acquisition unit that acquires a boundary information related to a boundary of a travel lane recognized by a driving control of the vehicle; a guidance information acquisition unit that acquires guidance information used for a route guidance; and a display control unit that displays an estimated trajectory content indicating an estimated trajectory of the vehicle, a driving of which is controlled based on the boundary information, to be superimposed on a road surface and displays a route guidance content for providing guidance on a route at a predetermined point based on the guidance information. The display control unit hides the estimated trajectory content and displays the route guidance content when the guidance information is acquired during display of the estimated trajectory content.

According to an aspect of the present disclosure, a display control program is used for a vehicle to control display on a head-up display, and causes one or more processors to perform a process including: acquiring boundary information related to a boundary of a travel lane recognized for a driving control of the vehicle; displaying an estimated trajectory content indicating an estimated trajectory of the vehicle, a driving of which is controlled based on the boundary information, to be superimposed on a road surface; acquiring guidance information used for a route guidance; and hiding the estimated trajectory content while displaying a route guidance content for providing guidance on a route at a predetermined point based on the guidance information, when the guidance information used for the route guidance is acquired during display of the estimated trajectory content.

According to an aspect of the present disclosure, a non-transitory computer-readable storage medium stores program instructions for controlling a head-up display of a vehicle. The program instructions causes one or more processors to: acquire boundary information related to a boundary of a travel lane recognized for a driving control of the vehicle; display an estimated trajectory content indicating an estimated trajectory of the vehicle, a driving of which is controlled based on the boundary information, to be superimposed on a road surface; acquire guidance information used for a route guidance; and hides the estimated trajectory content while displaying a route guidance content for providing guidance on a route at a predetermined point based on the guidance information, when the guidance information used for the route guidance is acquired during display of the estimated trajectory content.

In such aspects, the estimated trajectory content is hidden in response to acquiring the guidance information. Therefore, the display after the acquisition of the guidance information is such that the estimated trajectory is not presented. By switching the display in this way, it is possible to avoid a situation that a user feels difficult to understand the meaning of each content. Therefore, it is possible to display a plurality of contents in an easy-to-understand manner.

Hereinafter, a plurality of embodiments of the present disclosure will be described with reference to the drawings. In the following embodiments, corresponding components will be designated with the same reference numerals, and thus duplicate descriptions may be omitted. When only a part of the configuration is described in each embodiment, the configuration of the other embodiments described above can be applied to other parts of the configuration. Further, not only the combinations of the configurations explicitly shown in the description of the respective embodiments, but also the configurations of the plurality of embodiments can be partially combined even if the combinations are not explicitly shown if there is no problem in the combination in particular. Unspecified combinations of the configurations described in the plurality of embodiments and the modifications are regarded as being also disclosed in the following description.

### First Embodiment

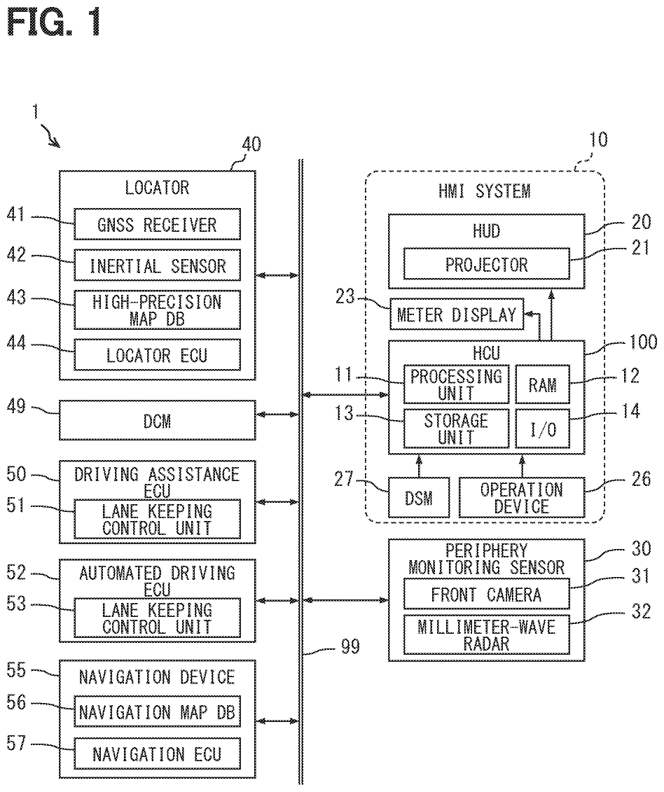

Functions of a display control device according to a first embodiment of the present disclosure is provided by a human machine interface (HMI) control unit 100 shown in FIGS. 1 to 3. Hereinafter, the HMI control unit 100 is also referred to as an HCU 100. The HCU 100 constitutes an HMI system 10 used in a vehicle A together with an in-vehicle display device such as a head-up display (hereinafter, HUD) 20 and a meter display 23. In addition, the HMI system 10 is configured to further include an operating device 26, a driver status monitor (hereinafter, DSM) 27, and the like. The HMI system 10 has an input interface function that accepts a user's operation made by an occupant (for example, a driver) of the vehicle A, and an output interface function that presents information to the driver.

The HMI system 10 is communicably connected to a communication bus 99 of an in-vehicle network 1 mounted on the vehicle A. The HMI system 10 is one of multiple nodes included in the in-vehicle network 1. A peripheral monitoring sensor 30, a locator 40, a DCM49, a driving assistance electronic control unit (ECU) 50, an automatic driving ECU 52, a navigation device 55, and the like are connected to the communication bus 99 of the vehicle-mounted network 1 as nodes. These nodes connected to the communication bus 99 can communicate with one another. The specific nodes of these devices and ECUs may be electrically, directly connected to each other to communicate with each other without passing through the communication bus 99.

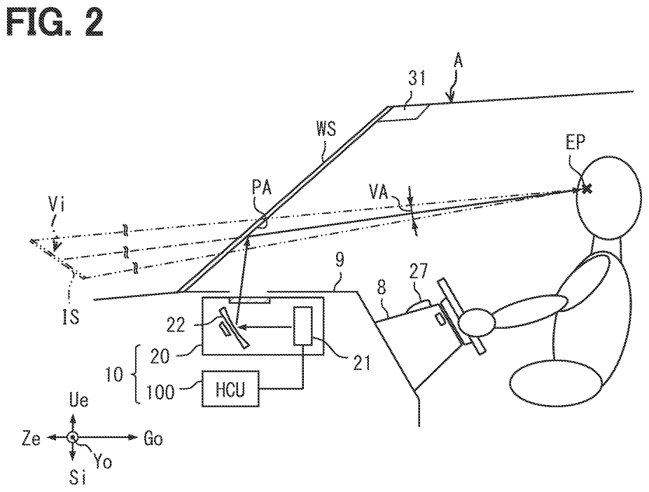

In the following description, a front-rear direction (see FIG. 2, Ze corresponding to forward, and Go corresponding to rearward) and a left-right (see FIG. 2, Yo corresponding to sideways) are defined with reference to the vehicle A motionlessly stationed on a horizontal plane. Specifically, the front-rear direction is defined along the longitudinal direction (traveling direction) of the vehicle A. The left-right direction is defined along a width direction of the vehicle A. Further, a vertical direction (see FIG. 2, Ue corresponding to upward and Si corresponding to downward) is defined along a direction vertical to the horizontal plane that defines the front-rear direction and the left-right direction. Further, for the sake of simplification of the description, the description of the reference numeral indicating each direction may be omitted as appropriate.

The periphery monitoring sensor 30 is an autonomous sensor that monitors a peripheral environment of the vehicle A. The periphery monitoring sensor 30 can detect moving objects and stationary objects in a detection range around the subject vehicle. The moving objects include pedestrians, cyclists, non-human animals, and other vehicles, for example. The stationary objects include falling objects on the road, guardrails, curbs, road signs, road markings such as road lane lines, and structures beside the road, for example. The peripheral monitoring sensor 30 provides the detection information of detecting an object around the vehicle A to the driving support ECU 50, the automatic driving ECU 52, and the like through the communication bus 99.

The periphery monitoring sensor 30 includes a front camera 31, a millimeter wave radar 32, and the like as detection configurations for object detection. The front camera 31 outputs at least one of image data obtained by photographing the front range of the vehicle A and an analysis result of the image data, as detection information. The multiple millimeter wave radars 32 are arranged, for example, on the front and rear bumpers of the vehicle A at intervals from each other. The millimeter wave radar 32 emits millimeter waves or quasi-millimeter waves toward a front range, a front side range, a rear range, a rear side range, or the like of the vehicle A. The millimeter wave radar 32 generates detection information by a process of receiving reflected waves reflected by moving objects, stationary objects, or the like. The vicinity monitoring sensor 30 may include detection configurations such as a lidar and a sonar.

The locator 40 generates highly accurate position information of the vehicle A by a complex positioning method that combines multiple types and pieces of acquired information. The locator 40 can specify a travelling lane on which the vehicle A travels among multiple lanes. The locator 40 includes a global navigation satellite system (GNSS) receiver 41, an inertial sensor 42, a high-precision map database (hereinafter, high-precision map DB) 43, and a locator ECU 44.

The GNSS receiver 41 receives positioning signals transmitted from multiple artificial satellites, such as positioning satellites. The GNSS receiver 41 is capable of receiving positioning signals from respective positioning satellites of at least one satellite positioning system among multiple satellite positioning systems such as GPS, GLONASS, Galileo, IRNSS, QZSS, and Beidou.

The inertial sensor 42 includes a gyro sensor and an acceleration sensor, for example. The high-precision map DB 43 is mainly composed of a non-volatile memory, and stores map data (hereinafter, high-precision map data) having higher accuracy than the map data used in the navigation device 55. The high-precision map data holds detailed information at least for information in the height (z) direction. The high-precision map data contains information that can be used for advanced driving assistance and automated driving, such as three-dimensional shape information about roads, information about the number of lanes, and information indicating a travelling direction allowed for each lane.

The locator ECU 44 mainly includes a microcomputer equipped with a processor, RAM, a storage unit, an input/output interface, and a bus connecting these elements. The locator ECU 44 combines positioning signal received by the GNSS receiver 41, measurement result of the inertial sensor 42, vehicle speed information output to the communication bus 99, and the like, and successively specifies the position and the travelling direction of the vehicle A. The locator ECU 44 provides the position information and the direction information of the vehicle A based on the positioning result to the navigation device 55, the HCU 100, the driving assistance ECU 50, the automatic driving ECU 52, and the like through the communication bus 99. In addition, the locator ECU 44 reads the corresponding high-precision map data from the high-precision map DB 43 in response to requests from the HCU 100, the driving assistance ECU 50, the automatic driving ECU 52, and the like, and provides the locator ECU 44 to the request source ECU.

A data communication module (DCM) 49 is a communication module mounted on the vehicle A. The DCM49 transmits and receives radio waves to and from base stations around the vehicle A by wireless communication compliant with communication standards such as long term evolution (LTE) and 5G. The DCM 49, when mounted, enables the vehicle A to be connect to the Internet. The DCM49 can acquire the latest high-precision map data from a cloud-based probe server. The DCM49 cooperates with the locator ECU 44 to update the high-precision map data stored in the high-precision map DB 43 to the latest information.

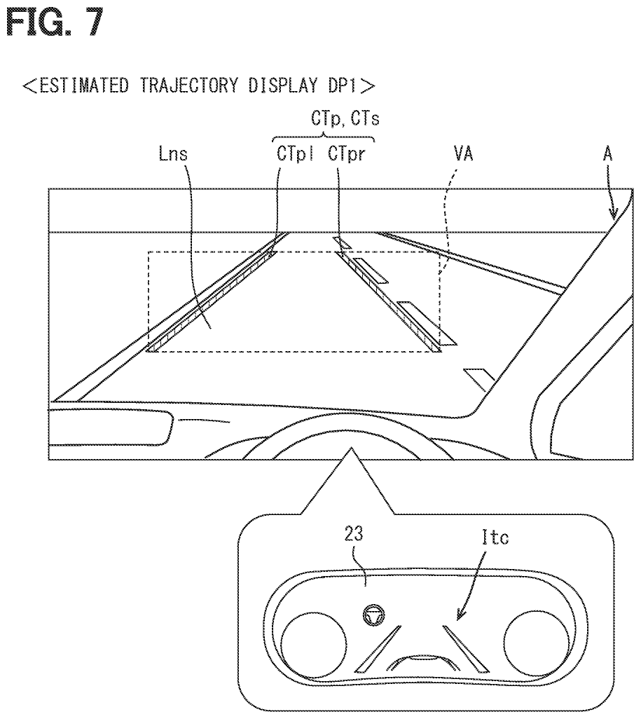

The driving assistance ECU 50 and the automatic driving ECU 52 are each configured to mainly include a computer including a processor, a RAM, a storage unit, an input/output interface, a bus connecting these components, and the like. The driving assistance ECU 50 has a driving assistance function to assist the driving operation of a driver. The automatic driving ECU 52 has an automatic driving function capable of acting as a driver's driving operation. As an example, the driving assistance ECU 50 enables partial automatic driving control (advanced driving assistance) of level 2 or lower, in an automatic driving level specified by the American Society of Automotive Engineers of Japan. On the other hand, the automatic driving ECU 52 enables automatic driving control of level 3 or higher. The driving assistance ECU 50 and the automatic driving ECU 52 each recognize the driving environment around the vehicle A for the driving control described later based on the detection information acquired from the peripheral monitoring sensor 30. Each of the driving assistance ECU 50 and the automatic driving ECU 52 provides the HCU 100 with the analysis result of the detection information carried out for recognizing the driving environment as the analyzed detection information. As an example, each of the driving assistance ECU 50 and the automatic driving ECU 52 can provide the HCU 100 with information, as boundary information related to a boundary of a travel lane, indicating relative positions of left and right markings or road edges and the shape of the lane on which the vehicle A is currently traveling (hereinafter referred to as the subject vehicle lane Lns, see FIG. 7). As described above, the left-right direction referred herein is a direction that coincides with the width direction of the vehicle A stationary on the horizontal plane, and is set with reference to the traveling direction of the vehicle A.

The driving assistance ECU 50 has a plurality of functional units that realize advanced driving assistance by executing a program by a processor. Specifically, the driving assistance ECU 50 has an adaptive cruise control (ACC) control unit and a lane keeping control unit 51. The ACC control unit is a functional unit that realizes the function of ACC for driving the vehicle A at a constant speed as a target vehicle speed or for driving the vehicle A to follow a leading vehicle while maintaining an inter-vehicular distance from the leading vehicle.

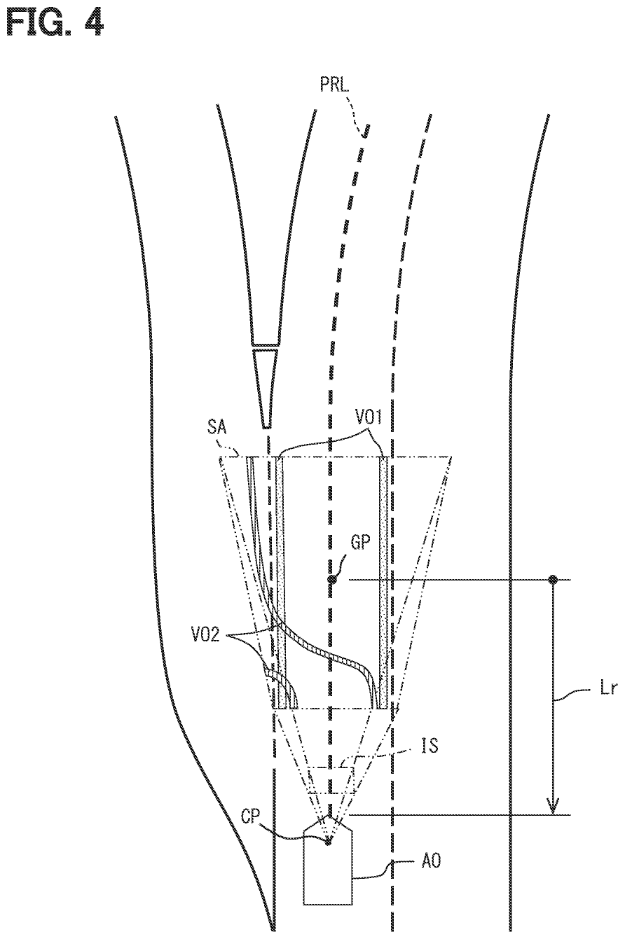

The lane keeping control unit 51 is a functional unit that realizes the function of a lane tracing assist (LTA). The LTA is also referred to as a lane trace control (LTC). The lane keeping control unit 51 controls the steering angle of the steering wheel of the vehicle A based on a position and shape information of the lane marking or the road edge extracted from the image data of the front camera 31. The lane keeping control unit 51 generates a scheduled traveling line PRL (see FIG. 4) having a shape along the subject vehicle lane Lns so that the vehicle A travels in the center of the subject vehicle lane Lns (see FIG. 7) on which the vehicle A is traveling. The lane keeping control unit 51 cooperates with the ACC control unit to perform driving control (hereinafter referred to as lane keeping control) for driving the vehicle A in the subject vehicle lane Lns according to the scheduled traveling running line PRL. The automatic driving ECU 52 has a plurality of functional units that realize autonomous driving of the vehicle A by executing a program by a processor. The automatic driving ECU 52 generates the scheduled traveling line PRL (see FIG. 4) based on the high-precision map data and the vehicle position information acquired from the locator 40 and the detection information acquired from the peripheral monitoring sensor 30. The automatic driving ECU 52 executes acceleration/deceleration control, steering control, and the like so that the vehicle A travels along the scheduled traveling line PRL.

The functional unit that causes the lane keeping control by the automatic driving ECU 52, which is substantially the same as the lane keeping control by the driving assistance ECU 50, that is, the functional unit that causes the vehicle A to travel in the subject vehicle lane Lns, is referred to as a lane keeping control unit for the convenience. A user can exclusively use one of the lane keeping control unit 51 and the lane keeping control unit 53.

When the lane keeping control is activated based on, for example, a user's operation on the operation device 26, the lane keeping control units 51 and 53 sequentially provide the lane keeping control information related to the lane keeping control to the HCU 100 through the communication bus 99. The lane keeping control information includes at least status information indicating the operating state of the lane keeping control and line shape information indicating the shape of the scheduled traveling line PRL.

The status information is information indicating whether the lane keeping control function is in an off state, a standby state, or an execution state. The standby state is a state in which the lane keeping control is activated but the motion control is not executed. On the other hand, the execution state is a state in which the driving control is activated based on the establishment of the execution condition. The execution condition is, for example, that the section lines on both sides can be recognized. The line shape information includes at least the three-dimensional coordinates of a plurality of specific points that define the shape of the scheduled traveling line PRL, the length and the radius of curvature of a virtual line connecting the specific points, and the like.

The line shape information may include a large amount of coordinate information. Each coordinate information is information indicating points lined up on the scheduled traveling line PRL at predetermined intervals. Even with the line shape information in such a data format, the HCU 100 can restore the shape of the scheduled traveling line PRL from a large amount of coordinate information.

The navigation device 55 is an in-vehicle device that cooperates with the HMI system 10 to provide route guidance to a destination set by an occupant. The navigation device 55 includes a map database for navigation (hereinafter, “navigation map DB”) 56, a navigation ECU 57, and the like. The navigation map DB 56 mainly includes a non-volatile memory, and comprehensively stores a wider range of map data than the high-precision map DB 43. The navigation map data stored in the navigation map DB 56 includes link data, node data, shape data, which are related to the roads.

The navigation ECU 57 mainly includes a microcomputer composed of a processor, a RAM, a storage unit, an input/output interface, a bus connecting these elements, and the like. The navigation ECU 57 acquires the position information and the direction information of the vehicle A from the locator ECU 44 through the communication bus 99. The navigation ECU 57 sets a destination by a driver operation, based on the operation information input to the operation device 26. The navigation ECU 53 searches for multiple routes to the destination so as to satisfy conditions such as time priority and distance priority. When one of the searched plurality of routes is selected, the navigation ECU 57 provides the route information based on the set route to the HCU 100 through the communication bus 99.

In addition, when the vehicle A approaches a guidance point GP such as an intersection or a branch point at which a right or left turn is made and that are included in the set route, the navigation ECU 57 sequentially outputs a guidance fulfillment request and a leading fulfillment request toward the HCU 100. The guidance point GP is set at the center of each intersection section and branching section as an example. The guidance point GP may be set on a near side or a far side of each of the intersection section and the branching section.

The guidance fulfillment request and the leading fulfillment request are guidance information used for route guidance to the driver. Specifically, the guidance fulfillment request and the leading fulfillment request include position information of the guidance point GP and information indicating a direction in which the vehicle A should proceed at the guidance point GP. The guidance fulfillment request is output at a timing when the remaining distance Lr (see FIG. 4) from the vehicle A to the guidance point GP becomes less than a first distance (for example, about 700 m). The leading fulfillment request is output at a timing when the remaining distance Lr to the guidance point GP becomes less than a second distance (for example, about 300 m). The HCU 100 presents information related to route guidance based on the acquisition of the guidance fulfillment request and the leading fulfillment request from the navigation ECU 57. An in-view angle distance is set to a distance at which the guidance point GP enters the angle of view VA (described later) of the HUD 20, or a distance slightly longer than the distance.

Next, details of the operation device 26, the DSM 27, the meter display 23, the HUD 20 and the HCU 100 included in the HMI system 10 will be described in order.

The operation device 26 is an input unit that accepts an operation of user, such as a driver. The operation device 26 receives the user operation for switching, for example, between an activated state and a deactivated state of the driving support function and the automatic driving function. Specifically, the operation device 26 includes a steering switch provided on a spoke portion of the steering wheel, an operation lever provided on a steering column portion 8, a voice input device for detecting the driver's voice or speech, or the like.

The DSM27 includes a near-infrared light source, a near-infrared camera, and a control unit for controlling the near-infrared light source and the near-infrared camera. The DSM 27 is installed on the upper surface of the steering column portion 8 or the upper surface of the instrument panel 9, for example, so that the near-infrared camera faces the headrest portion of the driver's seat. The DSM 27 uses the near-infrared camera to capture the driver's head to which the near-infrared light is emitted from the near-infrared light source. The control unit applies image analysis to images captured by the near-infrared camera. The control unit extracts information such as a position and an eye direction of the eye point EP from the captured image, and successively outputs the state information extracted to the HCU 100.

The meter display 23 is an in-vehicle display device installed in front of the driver's seat. The meter display 23 is mainly composed of a liquid crystal display, an organic light emitting diode (OLED) display, or the like. The meter display 23 is electrically connected to the HCU 100, and sequentially receives video data generated by the HCU 100. The meter display 23 presents various information related to the vehicle A to the driver by displaying as various images on a display screen, based on the video data.

The HUD 20 is mounted on the vehicle A as one of the multiple in-vehicle display devices along with the meter display 23, a center information display, and the like. The HUD 20 is electrically connected to the HCU 100 and successively acquires video data generated by the HCU 100. Based on the video data, the HUD 20 presents various information related to the vehicle A, such as route information, sign information, and control information of each in-vehicle function, to the driver using a virtual image Vi.

The HUD 20 is accommodated in a housing space inside the instrument panel 9 below a windshield WS. The HUD 20 projects the light formed as the virtual image Vi toward the projection range PA of the windshield WS. The light projected on the windshield WS is reflected toward the driver's seat in the projection range PA and is perceived by the driver. The driver visually recognizes a display in which a virtual image Vi is superimposed on the foreground visible through the projection range PA.

The HUD 20 includes a projector 21 and a magnifying optical system 22. The projector 21 includes a liquid crystal display (LCD) panel and a backlight. The projector 21 is fixed to a housing of the HUD 20 so that the display surface of the LCD panel faces the magnifying optical system 22. The projector 21 displays each frame image of the video data on the display surface of the LCD panel, and illuminates the display surface with the backlight that transmits the display surface. Thus, the light formed as a virtual image Vi is emitted toward the magnifying optical system 22. The magnifying optical system 22 includes at least one concave mirror in which metal such as aluminum is vapor-deposited on a surface of base material made of, such as synthetic resin or glass. The magnifying optical system 22 projects the light emitted from the projector 21 on an upper projection range PA while spreading the light by reflection.

The HUD 20 is given the angle of view VA. When a virtual range in the space where the virtual image Vi can be imaged by the HUD 20 is defined as an imaging plane IS, the angle of view VA is defined as an angle defined based on a virtual line connecting the driver's eye point EP and an outer edge of the image plane IS. The angle of view VA is a range of angle within which the driver can visually recognize the virtual image Vi when viewed from the eye point EP. In the HUD 20, a horizontal angle of view (for example, about 10 degrees to 12 degrees) in the horizontal direction is larger than a vertical angle of view (for example, about 4 degrees to 5 degrees) in the vertical direction. When viewed from the eye point EP, the front range (for example, a range of about a dozen m to 100 m) that overlaps with the image plane IS is the range within the angle of view VA.

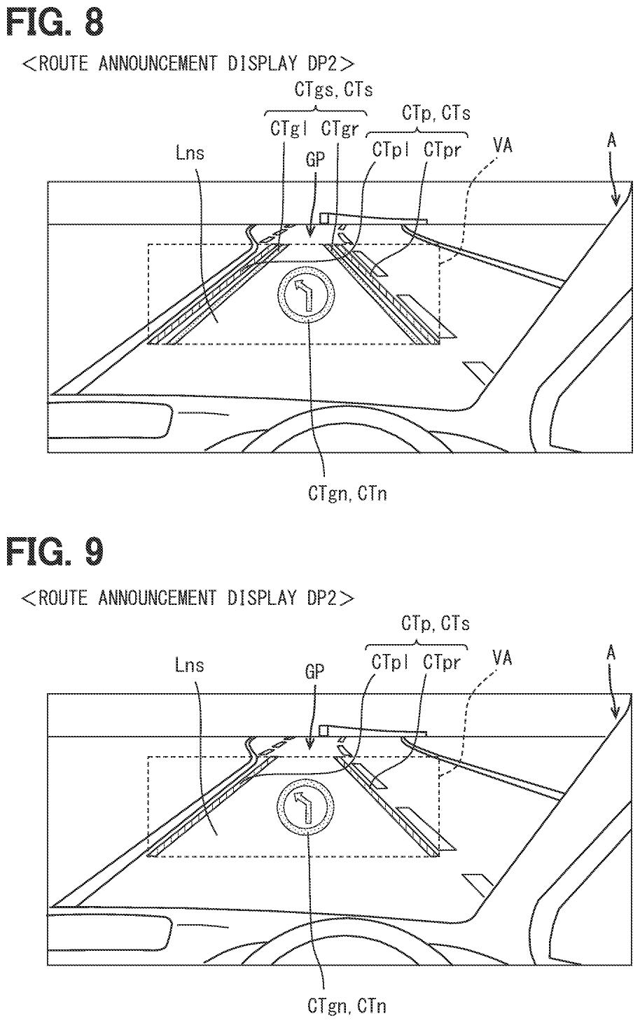

The HUD 20 displays a superimposition content CTs (see FIG. 7 and the like) and the non-superimposition content CTn (see FIG. 8 and the like) as virtual images Vi. The superimposition content CTs is an AR display objects used for augmented reality (hereinafter referred to as “AR”) display. The display position of the superimposition content CTs is associated with a specific superimposition target existing in the foreground, such as a specific position on the road surface, a vehicle in front, a pedestrian, and a road sign. The superimposition content CTs is displayed to be superimposed on a specific superimposition target in the foreground, and is seemingly fixed relative to the specific superimposition target to be able to follow the specific superimposition target corresponding to the driver's eye line. That is, the relative positional relationship is continuously maintained among the driver's eye point EP, the superimposition target in the foreground, and the superimposition content CTs. Therefore, the shape of the superimposition content CTs is continuously updated at a predetermined cycle according to the relative position and shape of the superimposition target. The superimposition content CTs is displayed in an orientation closer to horizontal than the non-superimposition content CTn, and have a display shape extended in the depth direction as seen from the driver, for example.

The non-superimposition content CTn is a non-AR display object excluding the superimposition content CTs among the display objects displayed in the superimposing manner in the foreground. Unlike the superimposition content CTs, the non-superimposition content CTn is displayed in the superimposing manner on the foreground independently of the superimposition target. The display position of the non-superimposition content CTn is not associated with a specific superimposition target. The non-superimposition content CTn is displayed at a fixed position within the projection range PA (the above-mentioned angle of view VA). Therefore, the non-superimposition content CTn is displayed as if it is relatively fixed to the vehicle configuration such as the windshield WS. In addition, the shape of the non-superimposition content CTn is substantially constant. Due to the positional relationship between the vehicle A and the superimposition target, the non-superimposition content CTn can also be displayed to be superimposed on the superimposition target of the superimposition content Cts.

The HCU 100 is an electronic control unit that integrally controls the display by a plurality of in-vehicle display devices including the HUD 20 in the HMI system 10. The HCU100, the HUD20, and the like constitute a virtual image display system.

The HCU 100 mainly includes a computer equipped with a processing unit 11, a RAM 12, a storage unit 13, an input/output interface 14, and a bus connecting these elements. The processing unit 11 is a hardware combined with the RAM 12, and executes arithmetic processing. The processing unit 11 includes at least one arithmetic core, such as a central processing unit (CPU) or a graphics processing unit (GPU). The processing unit 11 may further include a field-programmable gate array (FPGA), a neural network processing unit (NPU), an IP core having other dedicated functions, and the like. The RAM 12 may include a video RAM for generating video. The processing unit 11 accesses the RAM 12 to execute various processes for providing the functions of the respective functional blocks, which will be described later. The storage unit 13 includes a non-volatile storage medium. The storage unit 13 stores various programs (display control programs, etc.) to be executed by the processing unit 11.

The HCU 100 has a plurality of functional units for controlling the superimposition display of contents by the HUD 20 by executing the display control program stored in the storage unit 13 by the processing unit 11. Specifically, the HCU 100 is provided with functional units such as a viewpoint position specifying unit 71, a guidance information acquisition unit 72, a locator information acquisition unit 73, a control information acquisition unit 74, and a display generation unit 76.

The viewpoint position specifying unit 71 specifies a position of the eye point EP of the driver seated on the driver seat based on the state information acquired from the DSM 27. The viewpoint position specifying unit 71 generates three-dimensional coordinates (hereinafter referred to as eye point coordinates) indicating the position of eye point EP, and successively provides the generated eye point coordinates to the display generation unit 76.

The guidance information acquisition unit 72 acquires route information used for the route guidance to the destination when the destination is set in the navigation device 55. In addition, the guidance information acquisition unit 72 acquires the guidance fulfillment request and the leading fulfillment request, which are output by the navigation ECU 57 as the vehicle A approaches the guidance point GP.

The locator information acquisition unit 73 acquires the latest position information and direction information about the vehicle A from the locator ECU 44 as subject vehicle position information. In addition, the locator information acquisition unit 73 acquires high-precision map data of the peripheral range of the vehicle A from the locator ECU 44. The locator information acquisition unit 73 successively provides the acquired vehicle position information and high-precision map data to the display generation unit 76. When the locator information acquisition unit 73 cannot acquire the high-precision map data of the peripheral range of the vehicle A, the guidance information acquisition unit 72 may acquire the navigation map data from the navigation map DB 56.

The control information acquisition unit 74 acquires the status information and the line shape information output to the communication bus 99 by the lane keeping control units 51 and 53. In addition, the control information acquisition unit 74 acquires the boundary information of the subject vehicle lane Lns from at least one of the driving assistance ECU 50 and the automatic driving ECU 52. The control information acquisition unit 74 sequentially provides the display generation unit 76 with the status information, the line shape information, and the boundary information.

The control information acquisition unit 74 may acquire the imaging data of the front camera 31, instead of the boundary information as the analysis result acquired from the driving assistance ECU 50 or the automatic driving ECU 52. In this case, the control information acquisition unit 74 acquires boundary information by a process of extracting the left and right lane markings or road edges of the subject vehicle lane Lns from the imaging data.

The display generation unit 76 controls the presentation of information to the driver by the HUD 20 by generating video data that is sequentially output to the HUD 20. The display generation unit 76 draws the original image of each content displayed as a virtual image Vi on each frame image constituting the video data. When drawing the original image of the superimposition content CTs (see FIG. 7 and the like) on the frame image, the display generation unit 76 corrects the drawing position and drawing shape of the original image in the frame image according to the eye point EP and the superimposition target. Thus, the superimposition content CTs is displayed at the position and shape correctly superimposed on the superimposed object when viewed from the eye point EP.

The display generation unit 76 further has a virtual layout function and a content selection function in order to realize the above-mentioned video data generation function. The virtual layout function is a function of simulating the display layout of the superimposition content CTs based on various information provided to the display generation unit 76. When the display generation unit 76 acquires the status information indicating that the lane keeping control of any of the lane keeping control units 51 and 53 is turned on, the display generation unit 76 reproduces a current driving environment of the vehicle A in a virtual space based on the subject vehicle position information, the high-precision map data, the detection information, and the like.

More specifically, as shown in FIGS. 2 to 4, the display generation unit 76 sets a subject vehicle object AO at a reference position in the virtual three-dimensional space. The display generation unit 76 maps the road model of the shape indicated by the high-precision map data to the three-dimensional space in association with the subject vehicle object AO based on the subject vehicle position information. The display generation unit 76 sets the scheduled traveling line PRL having the shape based on the line shape information on the road model.

In addition, the display generation unit 76 sets a virtual camera position CP and a superimposition range SA in association with the subject vehicle object AO. The virtual camera position CP is a virtual position corresponding to the driver's eye point EP. The display generation unit 76 sequentially corrects the virtual camera position CP with respect to the subject vehicle object AO based on the latest eye point coordinates acquired by the viewpoint position specifying unit 71. The superimposition range SA is a range in which the virtual image Vi can be displayed in the superimposing manner. The display generation unit 76 sets a front range positioned inside the imaging plane IS as the superimposition range SA, when viewed forward from the virtual camera position CP, based on the virtual camera position CP and the outer edge position (coordinates) information of the imaging plane IS stored in advance in the storage unit 13 (see FIG. 1). The superimposition range SA corresponds to the angle of view VA of the HUD20.

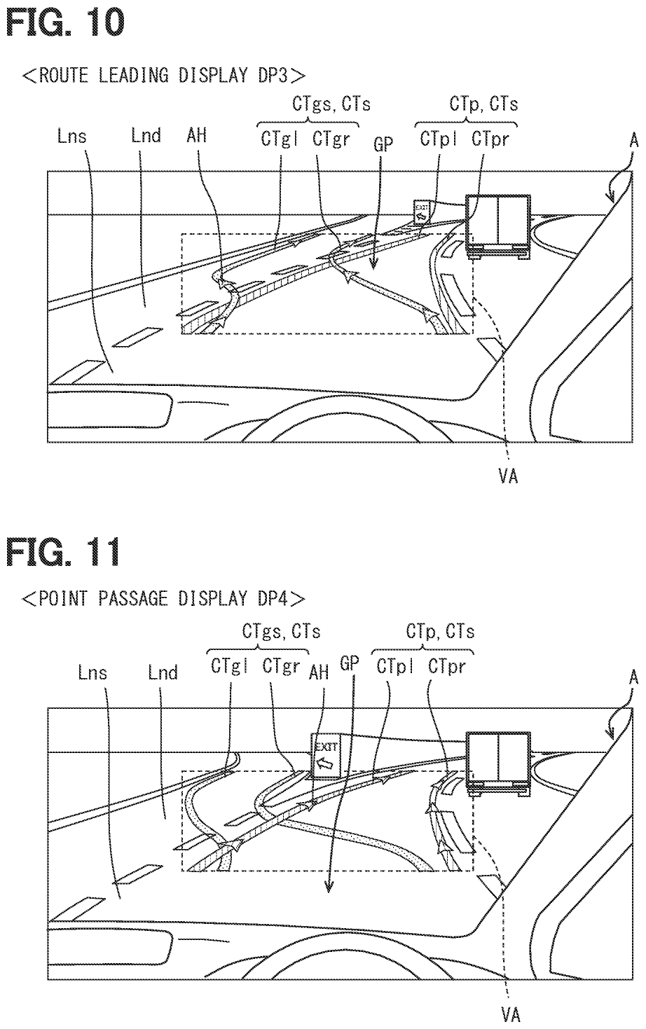

The display generation unit 76 can arrange a first virtual object VO1 and a second virtual object VO2 on the road surface of the road model in the three-dimensional space. The first virtual object VO1 is an object that defines the shape of an estimated trajectory content CTp (see FIG. 10), which will be described later. The first virtual object VO1 is set in the virtual space when the estimated trajectory content CTp is displayed as a virtual image. Based on the boundary information, the first virtual objects VO1 are arranged one by one in a strip-like shape at respective positions inside the left and right boundaries of a travel lane on which the scheduled traveling line PRL is laid.

The second virtual object VO2 is an object that defines the shape of a route guidance content CTgs (see FIG. 10), which will be described later. The second virtual object VO2 is set in the virtual space when the route guidance content CTgs is displayed as a virtual image. Similar to the first virtual objects VO1, a pair of second virtual objects VO2 are provided in the virtual space. Each second virtual object VO2 has a base end at a position inside of the corresponding first virtual object VO1 and extends in a strip shape in the direction indicated by the route information. The shape of each of the above virtual objects VO1 and VO2 viewed from the virtual camera position CP is a virtual image shape of each content CTp and CTgs visually recognized from the eye point EP.

The content selection function is a function for selecting a content to be used for presenting information. When the lane keeping control function is activated, for example, the display generation unit 76 selects the content to be drawn in the video data based on a simulation result of a display layout. The display generation unit 76 properly uses the superimposition content CTs and the non-superimposition content CTn, and presents information related to each of the lane keeping control and the route guidance to the driver.

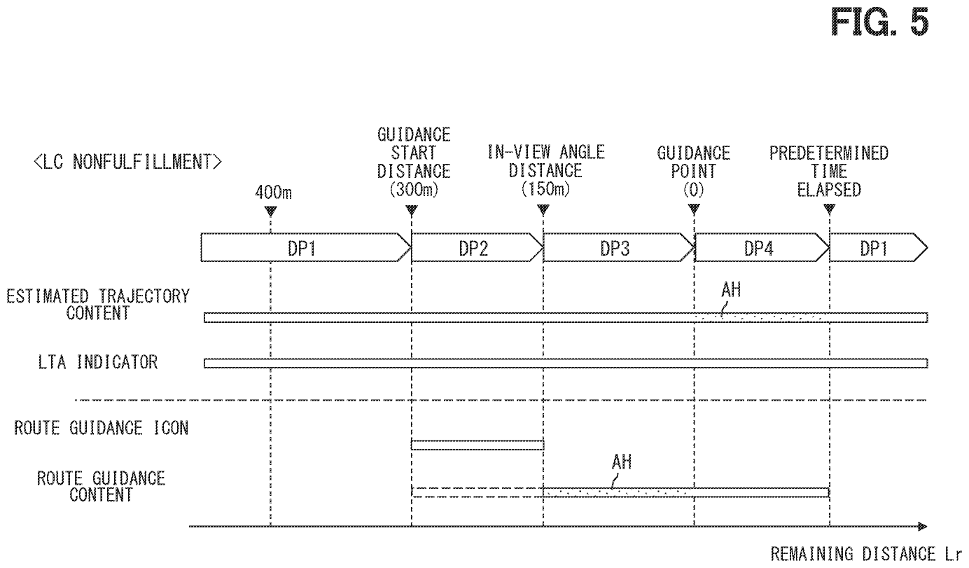

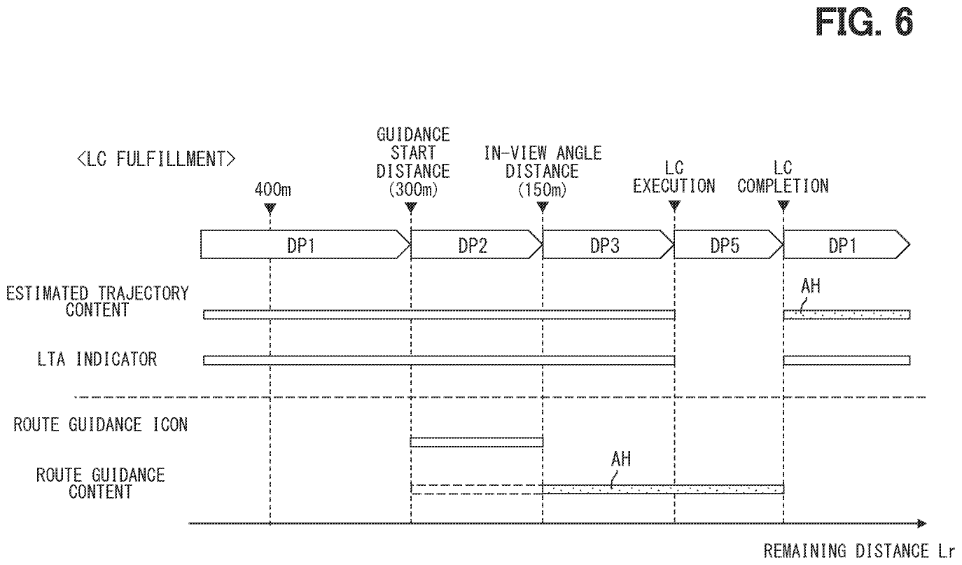

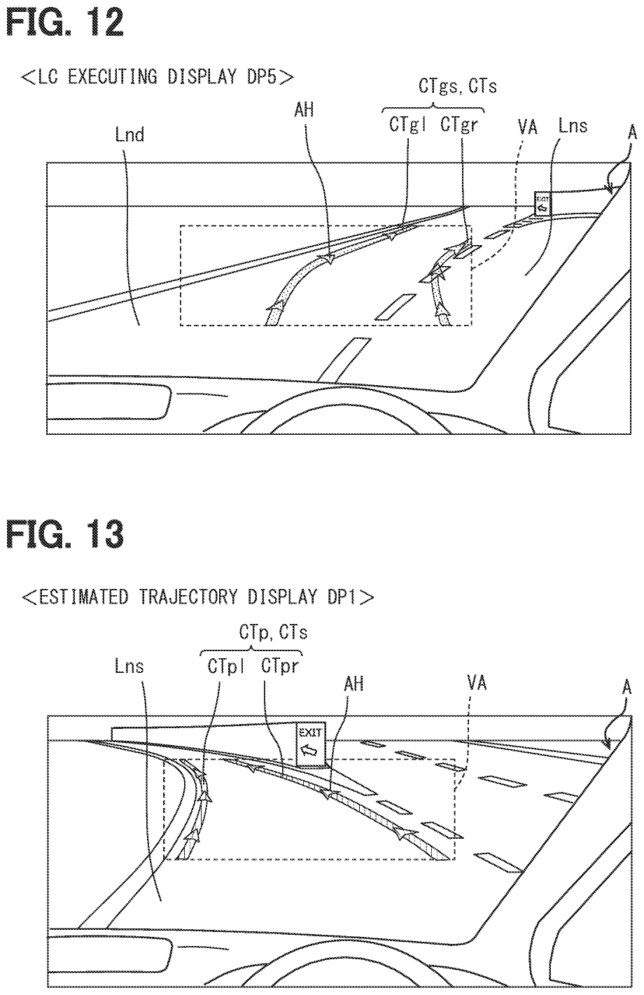

Specifically, the display generation unit 76 presents an estimated trajectory display DP1 (see FIGS. 7 and 13), a route announcement display DP2 (see FIGS. 8 and 9), and a route leading display DP3 (see FIG. 10) at the timings shown in FIGS. 5 and 6. Further, the display generation unit 76 presents a point passage display DP4 (see FIG. 11) or the like when the driver does not follow the route guidance, and presents a lane change executing display (hereinafter, LC executing display DP5, see FIG. 12) and the like when the driver follows the route guidance. These displays DP1 to DP5 include, as the virtual images Vi, the estimated trajectory content CTp (see FIGS. 7 to 11 and 13), the route guidance icon CTgn (see FIGS. 8 and 9), and the route guidance content CTgs (FIGS. 8, 10 to 12) and the like.

The estimated trajectory display DP1 shown in FIG. 7 is a display indicating that the lane keeping control is in the active state by any of the lane keeping control units 51 and 53. The estimated trajectory display DP1 includes the estimated trajectory content CTp. The estimated trajectory content CTp is a superimposition content CTs that is displayed to be superimposed on the road surface of the subject vehicle lane Lns in the foreground. The estimated trajectory content CTp includes a left boundary line CTpl and a right boundary line CTpr that define the vicinities of both edges of the subject vehicle lane Lns as superimposition targets.

The drawing positions and drawing shapes of the left boundary line CTpl and the right boundary line CTpr are determined based on the first virtual object VO1 (see FIG. 4) described above, respectively. The left boundary line CTpl has a shape extending in a strip shape in the traveling direction from the subject vehicle side along the left lane marking of the subject vehicle lane Lns. The right boundary line CTpr has a shape extending in a strip shape in the traveling direction from the subject vehicle side along the right lane marking of the subject vehicle lane Lns. Each of the boundary lines CTpl and CTpr is displayed so as to be attached to the road surface in an orientation along the road surface like a virtual road paint. When the subject vehicle lane Lns is straight, each of the boundary lines CTpl and CTpr has a straight linear shape. When the subject vehicle lane Lns is curved, each of the boundary lines CTpl and CTpr has a curved shape along the curve of the subject vehicle lane Lns. The drawing shapes of each of the boundary lines CTpl and CTpr is updated in a predetermined update cycle so as to match the road surface shape viewed from the eye point EP (see FIG. 2), as the vehicle A travels.

The estimated trajectory content CTp indicates that the lane keeping control unit 51, 53 is controlling the traveling position of the vehicle A within the subject vehicle lane Lns by displaying each of the boundary lines CTpl and CTpr extending along the lane markings. In addition, the estimated trajectory content CTp can indicate the estimated trajectory of the vehicle A traveling by the lane keeping control and a range recognized as travelable by the lane keeping control unit 51, 53 (hereinafter, travelable range).

The display generation unit 76 causes the HUD 20 to display the estimated trajectory content CTp and causes the meter display 23 to display a LTA indicator Itc, in a state where the lane keeping control is active. The LTA indicator Itc is an image unit showing an operating state of the lane keeping control. As an example, the LTA indicator Itc includes a lane marking image that imitates the left and right lane markings on the left and right side of the subject vehicle, thereby indicating that the lane keeping control is operating normally. In the first embodiment, switching between displaying and hiding of the LTA indicator Itc is synchronized with the estimated trajectory content CTp (see FIGS. 5 and 6).

The route announcement display DP2 shown in FIGS. 8 and 9 is a display for notifying the driver or the like in advance of the approach of the guidance point GP. The display generation unit 76 shifts from the estimated trajectory display DP1 (see FIG. 7) to the route announcement display DP2 at the timing when the guidance point GP is outside the angle of view VA, based on the acquisition of a guidance fulfillment request by the guidance information acquisition unit 72 (see FIGS. 5 and 6). Specifically, the display transition to the route announcement display DP2 is executed at a timing where a remaining distance Lr from the vehicle A to the guidance point GP becomes a specified distance (hereinafter, the guidance start distance, approximately 700 to 300m, for example 300m), after the guidance information acquisition unit 72 acquires the guidance fulfillment request. When the guidance point GP approaches the vehicle A while the lane keeping control is active, the route announcement display DP2 includes the route guidance icon CTgn and the route guidance content CTgs, in addition to the estimated trajectory content CTp (see FIG. 8) described above. Alternatively, the route announcement display DP2 in which, of the route guidance icon CTgn and the route guidance content CTgs, only the route guidance icon CTgn is displayed together with the estimated trajectory content CTp may be implemented (see FIG. 9). In other words, the route announcement display DP2 may not include the route guidance content CTgs.

The route guidance icon CTgn is a non-superimposition content CTn. The route guidance icon CTgn is visually recognized by the driver in a state of being displayed at a center of the angle of view VA and mainly superimposed on the road surface of the traveling lane. The route guidance icon CTgn is displayed in a posture that is raised from the road surface than the estimated trajectory content CTp so as to face the driver. The route guidance icon CTgn includes an arrow-shaped image portion and an outer peripheral image portion. The arrow-shaped image portion indicates the direction in which the vehicle A should head at the guidance point GP based on the guidance information. The outer peripheral image portion surrounds the arrow-shaped image portion in an annular shape. The route guidance icon CTgn is a content that plays a major role in the route announcement display DP2, and provides guidance on the route that the vehicle A should take at the guidance point GP.

The route guidance content CTgs is a superimposition content Cts, and displayed to be superimpose on the road surface of the subject vehicle lane Lns in the foreground inside the estimated trajectory content CTp. The route guidance content CTgs includes a left guidance line CTgl and a right guidance line CTgr having the vicinities of the both edges of the subject vehicle lane Lns as the superimposition targets. The drawing shapes of the left guidance line CTgl and the right guidance line CTgr are determined based on the second virtual object VO2 (see FIG. 4) described above. Each of the guidance lines CTgl and CTgr has a shape extending in a strip shape in a direction toward the destination from the subject vehicle side based on the route information. Each of the guidance lines CTgl and CTgr is displayed so as to stick to the road surface in an orientation along the road surface. In the route announcement display DP2 in which the guidance point GP is outside the angle of view VA, each of the guidance lines CTgl and CTgr has a shape extending in the traveling direction along the subject vehicle lane Lns as the traveling lane in an arrangement along the corresponding boundary line CTpl, CTpr. The display generation unit 76 may display an animation in which the guidance lines CTgl and CTgr repeatedly extend in n the traveling direction from the subject vehicle side, or an animation in which the guidance lines CTgl and CTgr repeatedly flow in the traveling direction from the subject vehicle side.

Each of the route guidance icon CTgn and the route guidance content CTgs described above is displayed in a mode different from that of the estimated trajectory content CTp. Specifically, at least one of the display color and the display brightness of the route guidance icon CTgn and the route guidance content CTgs is different from the estimated trajectory content CTp. As an example, the route guidance icon CTgn and the route guidance content CTgs are displayed in one of white and blue, and the estimated trajectory content CTp is displayed in the other of white and blue. As another example, the route guidance icon CTgn and the route guidance content CTgs are displayed with a display brightness higher than that of the estimated trajectory content CTp. Further, the route guidance icon CTgn may be displayed blinking.

The route leading display DP3 shown in FIG. 10 is a display encouraging the driver to perform a steering operation at the guidance point GP. Based on the acquisition of the leading fulfillment request by the guidance information acquisition unit 72, the display generation unit 76 switches the route announcement display DP2 (see FIG. 8) to the route leading display DP3 at the timing immediately before the guidance point GP moves into the angle of view VA. (See FIGS. 5 and 6.) Specifically, the display transition to the route leading display DP3 is executed at a timing at which the remaining distance Lr from the vehicle A to the guidance point GP becomes a specific distance (hereinafter, the in-view angle distance, about 300 to 150 m, for example 150m) after the guidance information acquisition unit 72 acquires the leading fulfillment request. In a case where the vehicle A reaches the guidance point GP while the lane keeping control is active, the route leading display DP3 includes both the estimated trajectory content CTp and the route guidance content CTgs.

The estimated trajectory content CTp includes boundary lines CTpl, CTpr extending along the left and right lane markings, as in the case of being included in the estimated trajectory display DP1 (see FIG. 7) and the route announcement display DP2 (see FIG. 8). The estimated trajectory content CTp indicates an estimated future trajectory of the vehicle A whose driving is controlled by any of the lane keeping control units 51 and 53.

The route guidance content CTgs is a superimposition content CTs for guiding the route to be taken by the vehicle A at the guidance point GP based on the guidance information. Here, the direction in which the vehicle A should travel at the guidance point GP is different from the direction in which the vehicle A continues to travel under the driving control. Therefore, in the route guidance content CTgs, each guidance line CTgl, CTgr is extended in a direction different from that of each boundary line CTpl, CTpr.

The route guidance content CTgs is displayed in a mode different from the estimated trajectory content CTp and emphasized with respect to the estimated trajectory content CTp. Specifically, a plurality of indicators AH are added to each of the guidance lines CTgl and CTgr (see dotted ranges in FIGS. 5 and 6). The indicator AHs are arranged on each of the guidance lines CTgl and CTgr at intervals from each other. Each of the indicators AH is drawn in a triangular shape indicating the direction of the guidance destination lane Lnd. In addition, the route guidance content CTgs is displayed as a wipe-like animation. Specifically, the route guidance content CTgs is displayed so as to repeatedly extends or flow from the subject vehicle side toward the guidance destination lane Lnd. Further, the display brightness of the route guidance content CTgs may be higher than the display brightness of the estimated trajectory content CTp. The route guidance content CTgs is displayed so as to be superimposed on the estimated trajectory content CTp, when viewed from the driver.

A point passage display DP4 shown in FIG. 11 is a display for notifying the driver of the passage of the guidance point GP. Based on the position information acquired by the locator information acquisition unit 73, the display generation unit 76 switches the route leading display DP3 (see FIG. 10) to the point passage display DP4 at a timing where the moving operation at the guidance point GP, such as moving to the guidance transition lane Lnd becomes difficult. The transition from the route leading display DP3 to the point passage display DP4 is performed when the driver does not follow the route guidance performed by the route leading display DP3. As an example, the display generation unit 76 performs the transition to the point passage display DP4 at the timing when the guidance point GP moves out of the angle of view VA (see FIG. 5). Since the active state of the lane keeping control is continued when there is no driving operation by the driver, the point passage display DP4 includes not only the route guidance content CTgs but also the estimated trajectory content CTp.

The route guidance content CTgs continues to indicate a movement trajectory when moving to the guidance destination lane Lnd by the guidance lines CTgl and CTgr, according to the approach of the vehicle A to the guidance point GP and the passage of the guidance point GP. Each of the guidance lines CTgl and CTgr in the point passage display DP4 is drawn in a shape that is sharply curved as compared with that of the route leading display DP3. In addition, the animation display of the route guidance content CTgs is not performed in the point passage display DP4. The route guidance content CTgs is hidden at the timing when the movement to the guidance destination lane Lnd becomes practically impossible.

The estimated trajectory content CTp is displayed in a mode different from that of the route guidance content CTgs, and is displayed in a mode emphasized with respect to the route guidance content CTgs. Specifically, in the point passage display DP4, the indicators AH are superimposed on the boundary lines CTpl and CTpr instead of the guidance lines CTgl and CTgr (see the dotted range in FIG. 5). Each of the indicators AH is drawn in a triangular shape indicating the traveling direction along the subject vehicle lane Lns. In addition, the estimated trajectory content CTp is displayed as a wipe-like animation, and specifically, is a display that repeatedly extends or flows from the subject vehicle side in the traveling direction. The display brightness of the estimated trajectory content CTp may be higher than the display brightness of the route guidance content CTgs. The estimated trajectory content CTp is displayed so as to be superimposed on the route guidance content CTgs when viewed from the driver.

The display generation unit 76 continues the point passage display DP4 for a predetermined time (or a predetermined distance), and then performs a display transition from the point passage display DP4 to the estimated trajectory display DP1. The display transition from the point passage display DP4 to the expected trajectory display DP1 may be performed, for example, at the timing when the vehicle A passes through a specific node.

A LC execution display DP5 shown in FIG. 12 is presented when the driver performs a lane change according to the route guidance provided by the route leading display DP3. The display generation unit 76 determines that the lane change is executed based on the input information of the on operation of the turn signal indicator (winker) by the driver, a determination result that the subject vehicle has crossed the lane marking between the subject vehicle lane Lns and the guidance destination lane Lnd, and the like. As an example, the detection information of the lane marking based on the imaging data is used to determine whether or not the vehicle A has crossed the lane marking. The display generation unit 76 switches from the route leading display DP3 (see FIG. 10) to the LC execution display DP5 at the timing when it is determined that the lane change is executed (see FIG. 6). According to the above-mentioned on operation (winker operation) of the turn signal indicator or the steering operation of the driver, the operation state of the lane keeping control changes from the execution state to a standby state. Therefore, while the LC execution display DP5 includes the route guidance content CTgs, the estimated trajectory content CTp is hidden. In the LC execution display DP5, the animation display of the route guidance content CTgs is continued as in the route leading display DP3.

When the lane change of the subject vehicle is completed, the display generation unit 76 fulfills a display transition from the LC execution display DP5 to the estimated trajectory display DP1 (see FIG. 13). As an example, the display generation unit 76 determines that the lane change is completed based on the transition of the turn signal to the off state or the return to the execution state of the lane keeping control. In the estimated trajectory display DP1, the route guidance content CTgs including the left boundary line CTpl and the right boundary line CTpr are displayed to be superimposed on the road surface of the previous guidance destination lane Lnd which has become the subject vehicle lane Lns. The route guidance content CTgs is highlighted by animation in a mode including the indicator AH. The display generation unit 76 shifts the route guidance content CTgs from the highlighting display to a normal display at the timing when a predetermined time has elapsed or when the vehicle has traveled for a predetermined distance after the completion of the lane change.

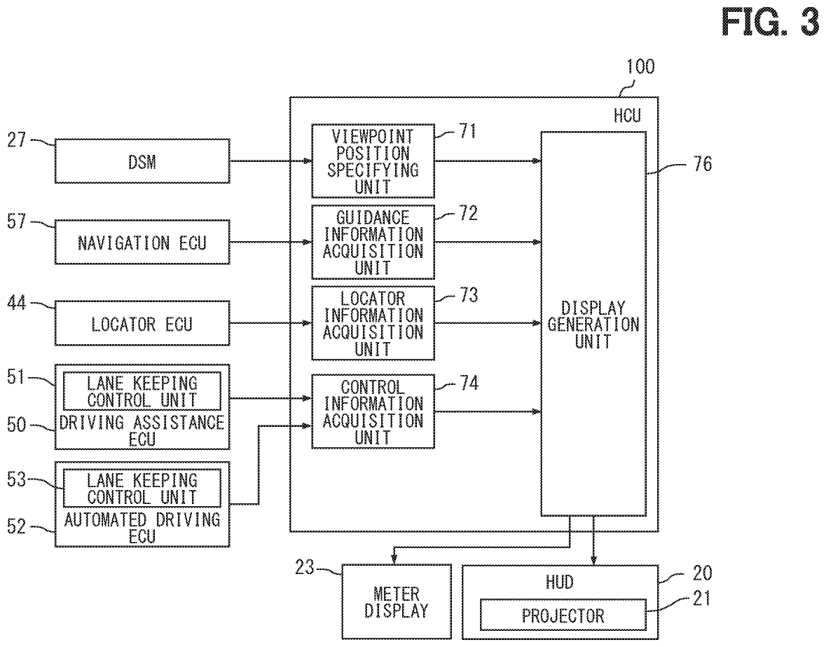

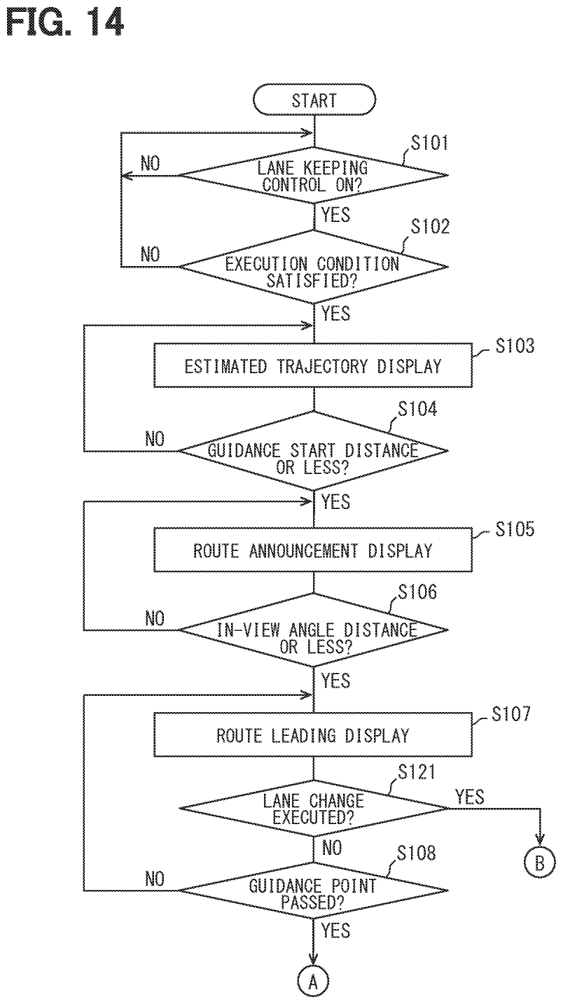

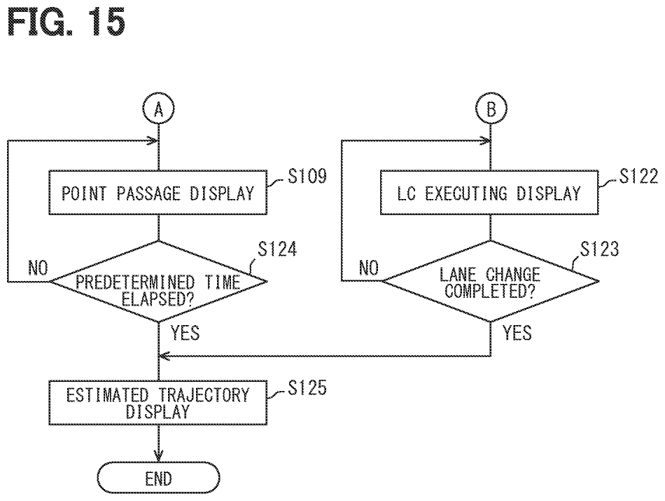

Next, details of a display control method for switching each display related to the lane keeping control and the route guidance will be described based on a display control program, with reference to flow charts shown in FIGS. 14 and 15, and FIG. 3 and FIGS. 5 to 13. The display control process shown in FIGS. 14 and 15 is started by the HCU 100 that has completed the start-up process or the like, for example, by switching the vehicle power supply to the on state.

In S101, based on the lane keeping control status information acquired by the control information acquisition unit 74, it is determined whether or not the lane keeping control by any of the lane keeping control units 51 and 53 is in the on state. When it is determined in S101 that the lane keeping control is not in the on state, the determination in S101 is repeated to maintain the standby state. At this time, at least the virtual image display related to the lane keeping control is not performed. Then, when the lane keeping control is switched to the on state by any of the lane keeping control units 51 and 53, the process proceeds to S102.

In S102, it is determined whether or not the execution condition of the lane keeping control is satisfied. When it is determined in S102 that the execution condition is not satisfied, the determinations in S101 and S102 are repeated to maintain the standby state. Then, when it is determined in S102 that the execution condition is satisfied, the process proceeds to S103. In this case, in parallel with the determination in S103, in any of the lane keeping control units 51 and 53, the lane keeping control shifts from the activated state to the execution state.

Here, the execution conditions of the lane keeping control by the lane keeping control units 51 and 53 are different from each other. Specifically, the execution condition of the lane keeping control by the lane keeping control unit 51 is that the two lane markings (or road edges) that sections the subject vehicle lane Lns can be recognized. On the other hand, the execution condition of the lane keeping control by the lane keeping control unit 53 is that two lane markings (or road edges) can be recognized as well as the high-precision map data exists.

In S103, the estimated trajectory display DP1 (see FIG. 7) indicating the execution state of the lane keeping control is started, and the process proceeds to S104. In S103, the HCU 100 refers to the boundary information acquired by the control information acquisition unit 74 from one of the driving assistance ECU 50 and the automatic driving ECU 52, the one having started the lane keeping control. Then, based on the boundary information, the estimated trajectory content CTp indicating the estimated trajectory of the vehicle A whose driving is controlled is displayed to be superimposed on the road surface of the subject vehicle lane Lns as the traveling lane.

In S104, it is determined whether or not the remaining distance Lr to the guidance point GP is less than the guidance start distance. In the determination of S104, the guidance fulfillment request acquired by the guidance information acquisition unit 72 is used. When the guidance fulfillment request is not acquired, the remaining distance Lr is considered to be equal to or greater than the guidance start distance in S104. In this case, the process returns to S103 to continue the estimated trajectory display DP1 including the estimated trajectory content CTp.

On the other hand, when the guidance fulfillment request is acquired and the remaining distance Lr based on the position information is less than the guidance start distance, the process proceeds from S104 to S105. In S104, it may be estimated that the remaining distance Lr is less than the guidance start distance with the acquisition of the guidance fulfillment request. In S105, the route announcement display DP2 (see FIG. 8) including the route guidance content CTgs and the route guidance icon CTgn is started in addition to the estimated trajectory content CTp is started, and the process proceeds to S106. When the display of the route guidance content CTgs is started in S105, the route guidance content CTgs may be displayed in animation.

In S106, it is determined whether or not the remaining distance Lr to the guidance point GP is less than the in-view angle distance. In the determination of S106, the leading fulfillment request acquired by the guidance information acquisition unit 72 is used. When the leading fulfillment request is not acquired, it is considered in S106 that the remaining distance Lr is equal to or greater than the in-view angle distance. In this case, the process returns to S105 and keeps to continue the route announcement display DP2.

On the other hand, when the leading fulfillment request is acquired and the remaining distance Lr based on the position information is less than the in-view angle distance, the process proceeds from S106 to S107. In S106, it may be estimated that the remaining distance Lr is less than the in-view angle distance with the acquisition of the leading fulfillment request. In S107, the route announcement display DP2 is switched to the route leading display DP3 (see FIG. 10), and the process proceeds to S121. In S107, the animation display of the route guidance content CTgs is started while hiding the route guidance icon CTgn. As described above, the route guidance content CTgs has a different mode from the estimated trajectory content CTp.

In S121, it is determined whether or not the lane change based on the route leading display DP3 is executed. When it is determined in S121 that the lane change is not executed, the process proceeds to S108. In S108, it is determined whether or not the vehicle A (subject vehicle) has passed the guidance point GP based on the comparison between the guidance point GP and the subject vehicle position. When it is determined in S108 that the vehicle A has not passed the guidance point GP, the process returns to S107 to continue the route leading display DP3. On the other hand, when the vehicle continues to travel in the lane by the lane keeping control, it is determined in S108 that the vehicle A has passed the guidance point GP, and the process proceeds to S109.

In S109, the route leading display DP3 is switched to the point passage display DP4 (see FIG. 11), and the process proceeds to S124. In S109, the animation display of the estimated trajectory content CTp is started. In addition, according to S109, the route guidance content CTgs ends the animation display and returns to the normal continuous display.

In S124, it is determined whether or not the point passage display DP4 has been continued to display for a predetermined time. When it is determined in S124 that the point passage display DP4 has been continued for a predetermined time, the process proceeds to S125, and the point passage display DP4 is switched to the estimated trajectory display DP1. As described above, the route guidance content CTgs is hidden based on the elapse of the predetermined time at the timing when the guidance destination lane Lnd is outside the angle of view VA.

On the other hand, when the driver changes lanes to the guidance destination lane Lnd according to the route guidance by the route leading display DP3, the lane keeping control is temporarily released and enters the standby state. When it is determined in S121 that the lane change according to the route guidance has been carried out, the process proceeds to S122. In S122, the route leading display DP3 is switched to the LC execution display DP5 (see FIG. 12), and the process proceeds to S123. For example, when the on operation of the turn signal switch by the driver is input, the estimated trajectory content CTp is hidden due to the display transition to the LC execution display DP5.

In S123, it is determined whether or not the lane change is completed. When it is determined in S123 that the lane change is continuing, the process returns to S122 to continue the LC execution display DP5. On the other hand, when it is determined in S123 that the lane change is completed, the process proceeds to S125 to switch from the LC execution display DP5 to the estimated trajectory display DP1 (see FIG. 13). As a result, the route guidance content CTgs is hidden when the lane keeping control is restarted.

In the first embodiment described so far, the estimated trajectory CTp and the route guidance content CTgs are displayed in different modes when displayed together. Therefore, even if the estimated trajectory content CTp and the route guidance content CTgs are combined on the display in the scene where the vehicle A reaches the guidance point GP and the route guidance is performed under the driving control of the vehicle A, the individual contents CTp and CTgs can be distinguished by a user. Therefore, it is possible to display a plurality of contents in an easy-to-understand manner.

In addition, in the first embodiment, the direction indicated by the estimated trajectory content CTp and the direction indicated by the route guidance content CTgs are different from each other. If the respective contents CTp and CTgs are displayed in a distinguishable manner in such a scene, the user can understand the meaning of the direction indicated by each content. Therefore, the content display that is excellent in user convenience is realized.

Further, in the first embodiment, when the remaining distance Lr to the guidance point GP exceeds the in-view angle distance, the route guidance icon CTgn, which is the non-superimposition content CTn, is displayed together with the estimated trajectory content CTp. By using such a non-superimposition content CTn, the user is notified in advance of the approach of the guidance point GP at the timing before the guidance point GP enters the angle of view VA.

Further, in the first embodiment, when the distance to the guidance point GP is less than the in-view angle distance, the route guidance content CTgs, which is the superimposition content CTs, is displayed to be superimposed on the road surface of the guidance point GP. According to the above, in the vicinity of the guidance point GP, the route to be taken at the guidance point GP is presented to be easily understandable to the user.

In addition, in the first embodiment, the estimated trajectory content CTp is hidden when the driver's on operation of the turn signal switch or a driver's steering operation toward the guidance destination lane Lnd is input. According to the above, since the number of contents displayed in the angle of view VA can be reduced, information presentation that is easy for the driver to understand is realized.

Further, in the first embodiment, when the display of the route guidance content CTgs is started on the route announcement display DP2, the route guidance content CTgs is displayed as an animation. According to the above, even if the estimated trajectory content CTp and the route guidance icon CTgn are both displayed, it is possible to attract the route guidance content CTgs. As a result, the driver's attention can be directed to the route guidance at an early stage.

In the first embodiment, the control information acquisition unit 74 corresponds to a “boundary information acquisition unit”, the display generation unit 76 corresponds to a “display control unit”, and the HCU 100 corresponds to a “display control device”. In addition to the route guidance content CTgs, the route guidance icon CTgn also corresponds to the “route guidance content CTgs”, the guidance point GP corresponds to a “predetermined point”, the in-view angle distance corresponds to a “specific distance”, and the subject vehicle lane Lns corresponds to a “travelling lane”.

### Second Embodiment

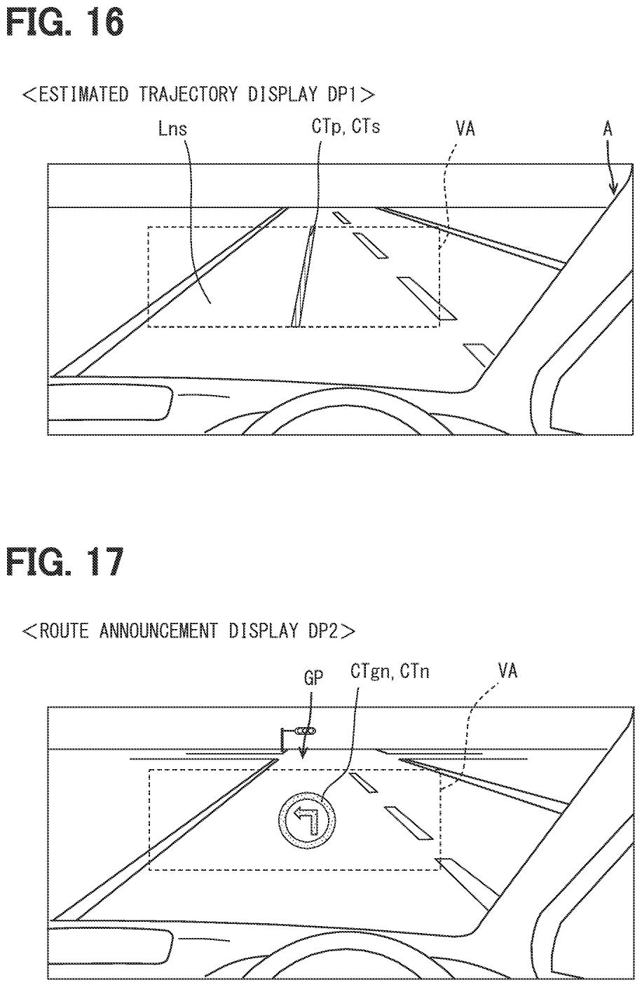

A second embodiment of the present disclosure illustrated in FIGS. 16 to 19 is a modification of the first embodiment. In the second embodiment, the content of each display related to lane keeping control and the route guidance is different from that in the first embodiment. Hereinafter, the details of the display of each pattern in the second embodiment will be described in order with reference to FIGS. 3 and 4.

An estimated trajectory display DP1 shown in FIG. 16 is presented when the lane keeping control is in the execution state, as in the first embodiment (see FIG. 14, S102: YES). An estimated trajectory content CTp included in the estimated trajectory display DP1 is a superimposition content CTs, and is displayed to be superimposed on the central portion of the road surface of the subject vehicle lane Lns in the foreground. The estimated trajectory content CTp has a drawing shape that reflects the scheduled traveling line PRL and, by extension, the line shape information. The estimated trajectory content CTp extends in a strip shape from the vehicle side in the traveling direction so as to follow the central portion of the road surface of the subject vehicle lane Lns. With such a shape, the estimated trajectory content CTp indicates that the lane keeping control unit 51 or 53 controls the traveling position of the vehicle A to the central portion of the subject vehicle lane Lns.

A route announcement display DP2 shown in FIG. 17 is started at a timing at which the remaining distance Lr to the guidance point GP (for example, an intersection) becomes less than the guidance start distance, as in the first embodiment (see FIG. 14, S104: YES). This route announcement display DP2 includes a route guidance icon CTgn indicating the direction of turning left or right at the guidance point GP. The route guidance icon CTgn continues to be displayed at a predetermined position in the angle of view VA in a substantially constant shape until just before the guidance point GP enters the angle of view VA.

Here, in the second embodiment, the estimated trajectory is positioned as information having a lower priority than the route guidance. Therefore, the estimated trajectory content CTp (see FIG. 16) is hidden as the transition from the estimated trajectory display DP1 to the route announcement display DP2. When the display generation unit 76 stops drawing the estimated trajectory content CTp on the video data output to the HUD 20, the display generation unit 76 draws the estimated trajectory content CTp on the video data output to the in-vehicle display device other than the HUD 20.

Specifically, the display generation unit 76 acquires the image data of the front camera 31 and generates image data (forward image) in which the original image of the estimated trajectory content CTp is superimposed on the subject vehicle lane Lns reflected in the image data. The display generation unit 76 outputs video data including the estimated trajectory content CTp toward at least one of a meter display 23 and a center information display. As described above, the presentation of the estimated trajectory content CTp is continued by the in-vehicle display device different from the HUD 20. An LTA indicator Itc (see FIG. 7) may be displayed instead of the front image.

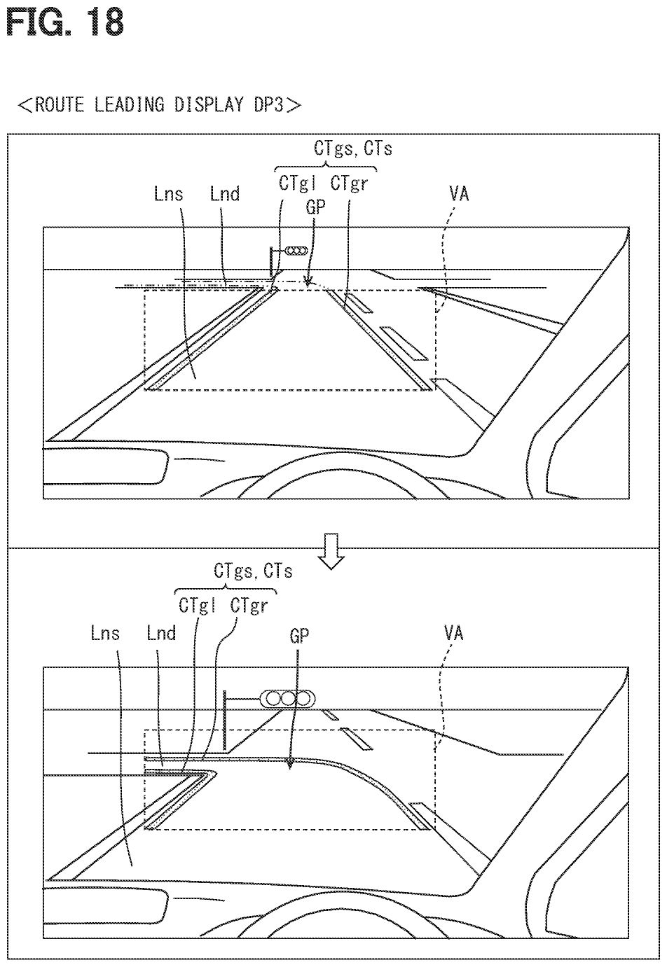

The route leading display DP3 shown in FIG. 18 is started at a timing when the remaining distance Lr to the guidance point GP (for example, an intersection) becomes less than the in-view angle distance (see FIG. 14, S106: YES), as in the first embodiment. In this route leading display DP3, the route guidance icon CTgn (see FIG. 17) is hidden. Then, the display content is switched from the route guidance icon CTgn to the route guidance content CTgs. Even after the transition from the route announcement display DP2 (see FIG. 17) to the route leading display DP3, the display of the estimated trajectory content CTp (see FIG. 16) by the other in-vehicle display device is continued.

The route guidance content CTgs includes a left guidance line CTgl and a right guidance line CTgr. Immediately after the display transition from the route announcement display DP2 to the route leading display DP3, at the timing when the guidance point GP is outside the angle of view VA, each of the guidance lines CTgl and CTgr has a drawing shape that extends in a strip shape along a left or right lane marking of the subject vehicle lane Lns. Then, when the guidance point GP enters the angle of view VA, each of the guidance lines CTgl and CTgr has a curved shape extending from the subject vehicle side toward a travel lane (hereinafter referred to as the guidance destination lane Lnd) after turning left or right.

In the case where the driver performs a steering operation such as a right turn or a left turn in accordance with the above route leading display DP3, the display generation unit 76 terminates to display the route guidance content CTgs after the vehicle A travels the guidance destination lane Lnd for a predetermined distance or a predetermined time. As described above, when the guidance point GP is an intersection, the display of the route guidance content CTgs is continued even after the on operation of the turn signal switch and the steering operation are input. The display generation unit 76 executes the display transition from the route guidance content CTgs (route leading display DP3) to the estimated trajectory content CTp (estimated trajectory display DP1) after traveling for the predetermined distance or the predetermined time.

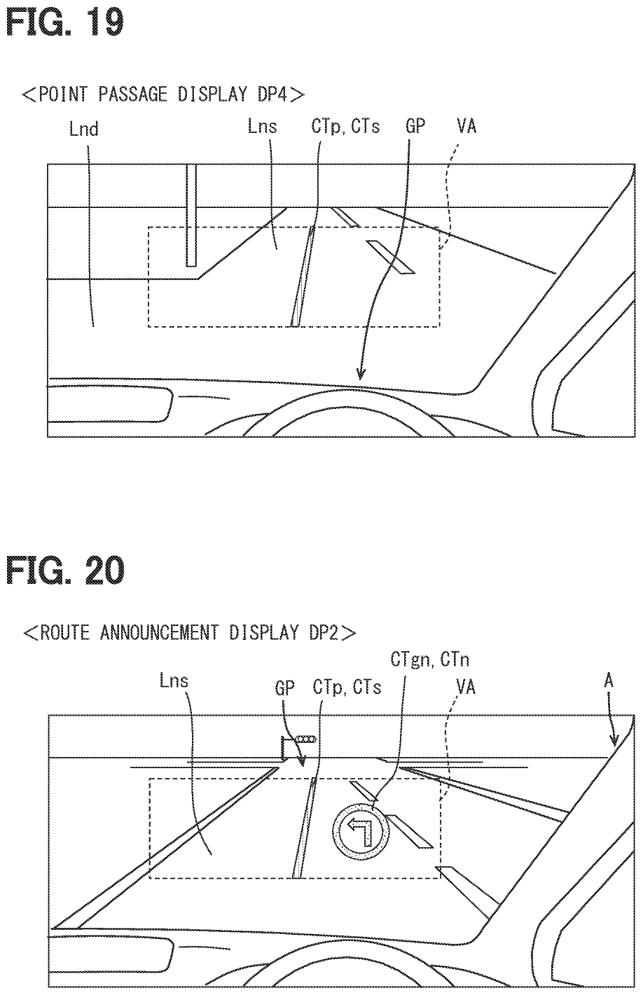

A point passage display DP4 shown in FIG. 19 is started at the timing when the subject vehicle has passed the guidance point GP and the turning left or right to the guidance destination lane Lnd becomes substantially unavailable (see FIG. 14, S108: YES). In the point passage display DP4, the display of the route guidance content CTgs (see FIG. 18) is terminated. Then, the display of the estimated trajectory content CTp superimposed on the subject vehicle lane Lns is resumed. At this time, the display of the estimated trajectory content CTp by the other in-vehicle display device is terminated.

In the second embodiment described so far, the estimated trajectory content CTp is hidden when the guidance fulfillment request is acquired by the guidance information acquisition unit 72. Specifically, the route announcement display DP2 and the route leading display DP3, which are presented after the acquisition of the guidance fulfillment request, do not present the estimated trajectory. As described above, according to the display logic that reduces the content to be displayed in the angle of view VA, it is possible to avoid a situation in which it becomes difficult to understand the meaning of each content due to the simultaneous display of a plurality of contents. Therefore, it is possible to display a plurality of contents in an easy-to-understand manner.

In addition, in the second embodiment, the presentation of the estimated trajectory content CTp to the user is continued by the in-vehicle display device such as the meter display 23 and the center display. Therefore, even after the display by the virtual image Vi is stopped, the means for recognizing the estimated trajectory of the vehicle A remains. Therefore, it is possible to realize the content display that ensures convenience while avoiding user confusion. In the second embodiment, the guidance fulfillment request corresponds to “guidance information”, and the meter display 23 corresponds to a “display” or “display device”.

### Third Embodiment

A third embodiment of the present disclosure shown in FIGS. 20 to 22 is a modification of the second embodiment. In the third embodiment, the contents of the route announcement display DP2, the route leading display DP3, and the point passage display DP4 are different from those in the second embodiment. Hereinafter, the details of the display of each pattern in the third embodiment will be described in order. An estimated trajectory display DP1 in the third embodiment is substantially the same as the estimated trajectory display DP1 (see FIG. 16) in the second embodiment.

A route announcement display DP2 shown in FIG. 20 includes an estimated trajectory content CTp and a route guidance icon CTgn. In the third embodiment, the estimated trajectory content CTp is not hidden even if the estimated trajectory display DP1 is transitioned to the route announcement display DP2. The estimated trajectory content CTp is superimposed on the central portion of the road surface of the subject vehicle lane Lns based on the shape information of the scheduled traveling line PRL (see FIG. 4), and continues to present the estimated trajectory of the vehicle A. The display position of the route guidance icon CTgn is set on either the left or right side of the estimated trajectory content CTp so as not to overlap with the estimated trajectory content CTp. The route guidance icon CTgn indicates the direction of turning left or right at the guidance point GP (intersection) based on the route information.

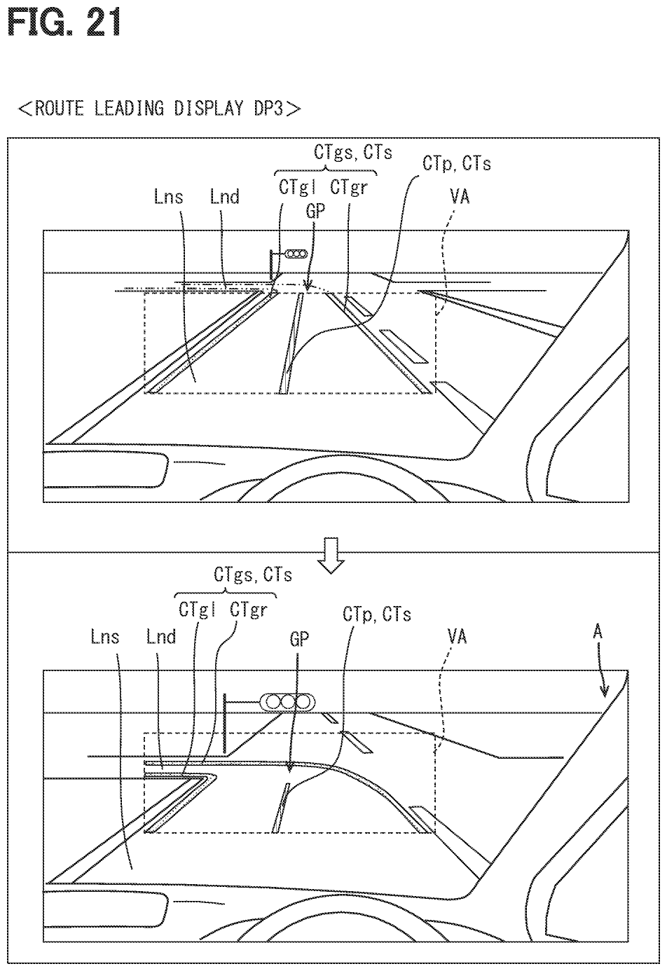

In the route leading display DP3 shown in FIG. 21, the route guidance content CTgs is displayed instead of the route guidance icon CTgn (see FIG. 20). As a result, in the route leading display DP3, the estimated trajectory content CTp is arranged so as to be sandwiched between the left guidance line CTgl and the right guidance line CTgr. Immediately after the display transition to the route leading display DP3, at the timing when the guidance point GP is outside the angle of view VA, the estimated trajectory content CTp and each of the guidance lines CTgl and CTgr have drawing shapes each extending in a stripe shape from the subject vehicle side in the traveling direction.

In the route leading display DP3, a display range, that is, a road surface range of superimposition of the estimated trajectory content CTp is limited. When the estimated trajectory content CTp is displayed together with the route guidance content CTgs, the display range of the estimated trajectory content CTp is limited on a near side of the intersection as the guidance point GP, that is, limited a range not beyond the intersection as the guidance point GP. Therefore, the estimated trajectory content CTp is gradually shortened as the vehicle A approaches the guidance point GP.

When the guidance point GP is located within the angle of view VA, each of the guidance lines CTgl and CTgr has a curved shape extending from the subject vehicle side in the subject vehicle lane Lns toward the guidance destination lane Lnd. When the guidance point GP is an intersection such as a crossroads, each of the guidance lines CTgl and CTgr has an L-shaped drawing shape passing through the intersection. Since the display range of the estimated trajectory content CTp is limited to the range not beyond the guidance point GP, the guidance lines CTgl and CTgr are displayed so as not to overlap with the estimated trajectory content CTp.

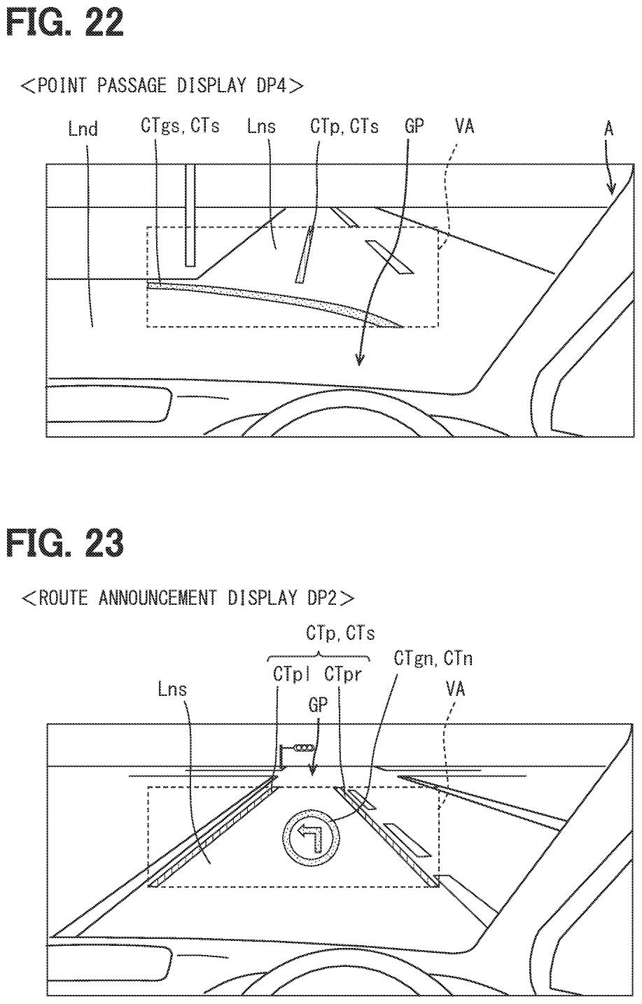

A point passage display DP4 shown in FIG. 22 includes a route guidance content CTgs and an estimated trajectory content CTp. When the vehicle A passes through the guidance point GP, the route guidance content CTgs gradually frames out from the angle of view VA and disappears as the guidance point GP moves out of the angle of view VA. The display range of the estimated trajectory content CTp is set so as to avoid the intersection including the guidance point GP, similarly to the route leading display DP3. When the vehicle A passes through the guidance point GP, the estimated trajectory content CTp is displayed to be superimposed on the central portion of the subject vehicle lane Lns located ahead of the intersection. Therefore, even in the point passage display DP4, the estimated trajectory content CTp is displayed so as not to overlap with the route guidance content CTgs.

In the third embodiment described so far, when the estimated trajectory content CTp and the route guidance content CTgs are displayed together, the display of the estimated trajectory content CTp is limited to the range not beyond the guidance point GP. Therefore, even if the estimated trajectory content CTp and the route guidance content CTgs are combined on the display, the individual contents CTp and CTgs can be distinguished by the user. Therefore, it is possible to display a plurality of contents in an easy-to-understand manner.

In addition, the display range of the estimated trajectory content CTp of the third embodiment is limited so as not to overlap with the route guidance content CTgs. As described above, when the two contents are displayed so as not to overlap each other, the user can more easily distinguish the contents from each other. As a result, more convenient information presentation is realized.

### Fourth Embodiment

A fourth embodiment of the present disclosure shown in FIGS. 23 to 25 is another modification of the first embodiment. In the fourth embodiment, the contents of the route announcement display DP2, the route leading display DP3, and the point passage display DP4 are different from those in the first embodiment. Hereinafter, the details of the display of each pattern in the fourth embodiment will be described in order. An estimated trajectory display DP1 in the fourth embodiment is substantially the same as the estimated trajectory display DP1 (see FIG. 7) of the first embodiment.

A route notice display DP2 shown in FIG. 23 includes an estimated trajectory content CTp and a route guidance icon CTgn. The estimated trajectory content CTp includes a left boundary line CTpl and a right boundary line CTpr, as in the first embodiment. The route guidance icon CTgn is displayed in the center of the angle of view VA, and is located between the left and right lane markings of the subject vehicle lane Lns or the boundary lines CTpl and CTpr extending along the left and right road edges.

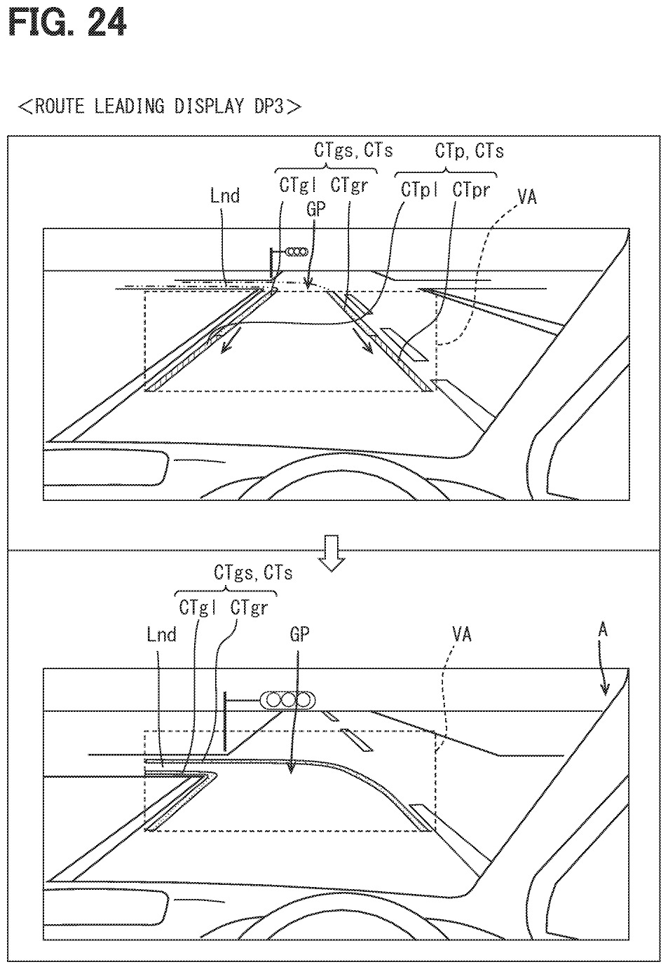

In a route leading display DP3 shown in FIG. 24, a route guidance content CTgs is displayed instead of the route guidance icon CTgn (see FIG. 23). The route guidance content CTgs includes a left guidance line CTgl and a right guidance line CTgr. The display generation unit 76 (see FIG. 3) begins animation display to insert each of the guidance lines CTgl and CTgr in the angle of view VA while hiding the route guidance icon CTgn at the in-view angle distance, in response to the acquisition of the leading fulfillment request. The display generation unit 76 displays an animation in which each of the guidance lines CTgl and CTgr is extended from the guidance point GP toward the subject vehicle side so as to overlap the corresponding one of the boundary lines CTpl and CTpr. As a result, each of the guidance lines CTgl and CTgr is displayed in the angle of view VA so as to overwrite each of the boundary lines CTpl and CTpr.

As described above, the estimated trajectory content CTp is hidden at the timing when the guidance point GP is located within the angle of view VA. Therefore, the route leading display DP3 includes the route guidance content CTgs and does not include the estimated trajectory content CTp, as in the second embodiment. The route leading display DP3 provides a guidance on the route that the vehicle A should take at the guidance point GP by the guidance lines CTgl and CTgr extending from the subject vehicle side toward the guidance destination lane Lnd. Also in the fourth embodiment, the presentation of the estimated trajectory content CTp is continued by an in-vehicle display device different from the HUD 20.

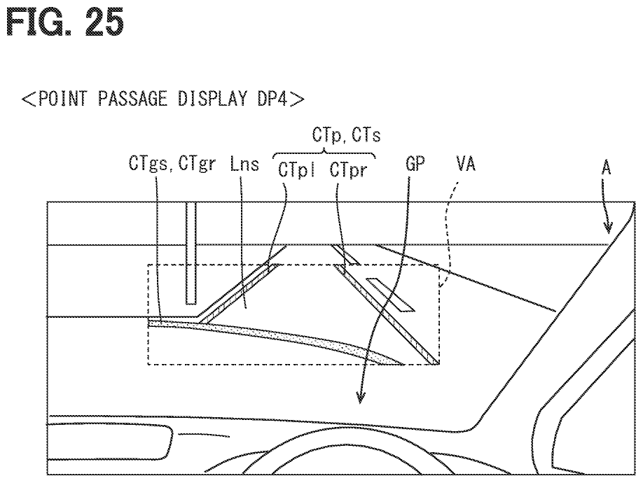

A point passage display DP4 shown in FIG. 25 includes a route guidance content CTgs and an estimated trajectory content CTp. The route guidance content CTgs gradually frames out from the angle of view VA as the vehicle A passes the guidance point GP, and is then hidden. As a result, the display state changes from the point passage display DP4 to the estimated trajectory display DP1. In the point passage display DP4, the estimated trajectory content CTp is displayed outside the route guidance content CTgs. In other words, each of boundary lines CTpl and CTpr of the estimated trajectory content CTp extends along the subject vehicle lane Lns from the right guidance line CTgr in the traveling direction.

In the fourth embodiment described so far, the estimated trajectory content CTp is hidden when the leading fulfillment request is acquired by the guidance information acquisition unit 72. Therefore, the route leading display DP3 does not present the estimated trajectory. By switching the display in this way, it is possible to avoid a situation in which it becomes difficult to understand the meanings of the estimated trajectory content CTp and the route guidance content CTgs. Therefore, it is possible to display a plurality of contents in an easy-to-understand manner.

In addition, in the fourth embodiment, the estimated trajectory content CTp is hidden after the route guidance content CTgs is displayed by displaying the animation in which the guidance lines CTgl and CTgr are superimposed on the boundary lines CTpl and CTpr. The display transition using such an animation makes it easier for the user to recognize that the information presented by the content has been changed. Therefore, user confusion is less likely to occur.

Further, in the fourth embodiment, even when the remaining distance Lr exceeds the in-view angle distance, the route guidance icon CTgn is displayed together with the estimated trajectory content CTp to notify the driver of the existence of the guidance point GP. According to such a route announcement display DP2, it is possible to make the user recognize the approach of the guidance point GP with a sufficient margin before the guidance point GP enters the angle of view VA.

Further, in the fourth embodiment, when the remaining distance Lr is less than the in-view angle distance, the display of the estimated trajectory content CTp is finished, and then the route guidance content CTgs is displayed. Therefore, in the vicinity of the guidance point GP, the route to be followed at the guidance point GP can be shown in an easy-to-understand manner to the user. In the fourth embodiment, the leading fulfillment request corresponds to “guidance information”.

### Fifth Embodiment

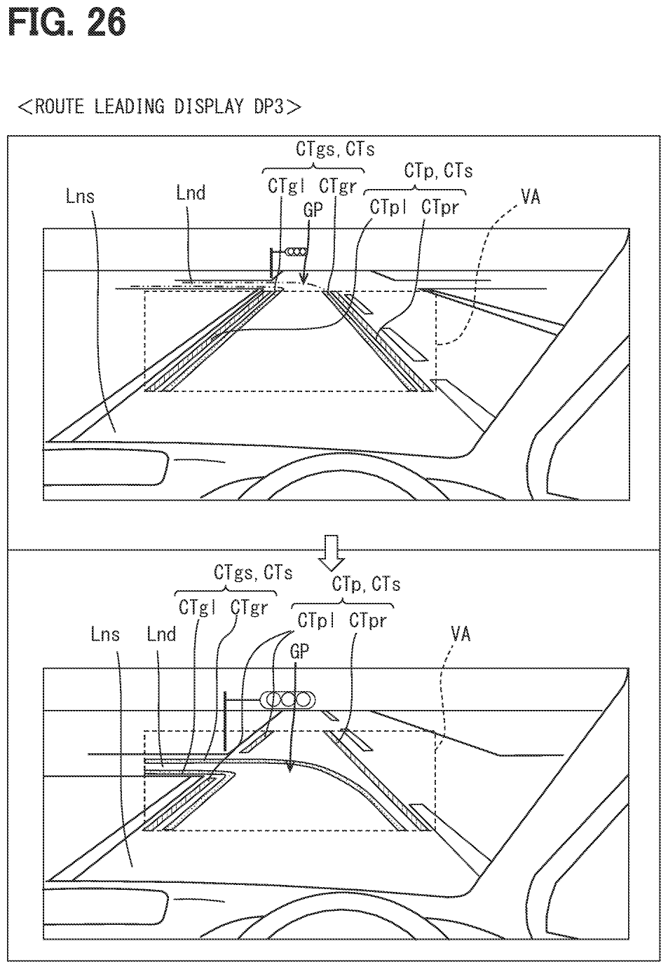

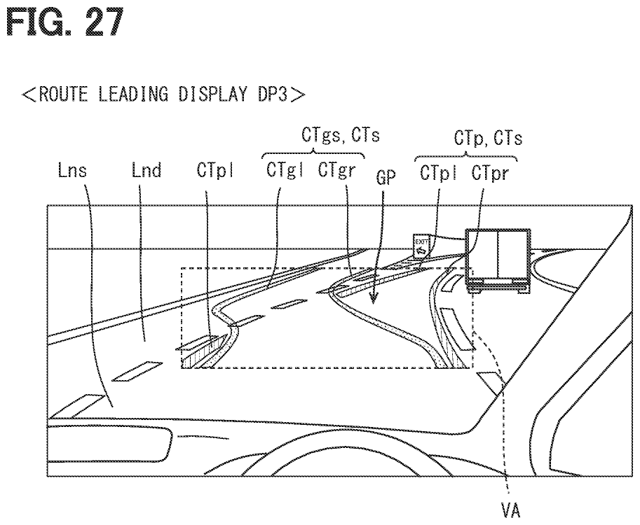

A fifth embodiment of the present disclosure shown in FIGS. 26 and 27 is still another modification of the first embodiment. In the fifth embodiment, the content of a route leading display DP3 is different from that of the first embodiment. On the other hand, an estimated trajectory display DP1 and a route announcement display DP2 of the fifth embodiment are substantially the same as the respective displays (see FIGS. 7 and 8) of the first embodiment. Further, a point passage display DP4 of the fifth embodiment is substantially the same as the point passage display DP4 (see FIG. 25) of the fourth embodiment.

In the route leading display DP3 of the fifth embodiment, an estimated trajectory content CTp and a route guidance content CTgs are both displayed. In the route leading display DP3 at the intersection shown in FIG. 26, the guidance lines CTgl and CTgr are displayed inside the boundary lines CTpl and CTpr at the timing when the guidance point GP is outside the angle of view VA. Then, at the timing when the guidance point GP is located within the angle of view VA, the display generation unit 76 (see FIG. 3) displays the route guidance content CTgs and the estimated trajectory content CTp so as to be different from each other.

The route guidance content CTgs extends each of the guidance lines CTgl and CTgr in an L shape from the subject vehicle lane Lns to the guidance destination lane Lnd. On the other hand, the estimated trajectory content CTp extends each of the boundary lines CTpl and CTpr linearly along the subject vehicle lane Lns. As described above, an intermediate portion of the left boundary line CTpl is a portion that overlaps with the respective guidance lines CTgl and CTgr. The display generation unit 76 changes the mode of the intermediate portion of the left boundary line CTpl that overlaps with each of the guidance lines CTgl and CTgr to locally hide the display. As a result, the left boundary line CTpl has a drawing shape extending on the near side and the far side of the guidance point GP (intersection).

More accurately, the intermediate portion of the left boundary line CTpl that overlaps with each of the guidance lines CTgl and CTgr is a portion that overlaps with each of the guidance lines CTgl and CTgr when the left boundary line CTpl having a reference shape is displayed.

Further, as shown in FIG. 27, even in the route leading display DP3 at the branch point, the intermediate portion of the left boundary line CTpl extending along the subject lane Lns is locally hidden so as not to overlap with the respective guidance lines CTgl and CTgr. As a result, each of the guidance lines CTgl and CTgr extending from the subject vehicle lane Lns to the guidance destination lane Lnd is in a state of being emphasized more than the estimated trajectory content CTp.

Each of the guidance lines CTgl and CTgr and each of the boundary lines CTpl and CTpr may be displayed as an animation that repeatedly extends from the subject vehicle side in the traveling direction. Alternatively, only each of the guidance lines CTgl and CTgr may be displayed as an animation that repeatedly extends from the subject vehicle side toward the guidance destination lane Lnd. Alternatively, it is not always necessary to perform these animations.

Also in the fifth embodiment described so far, the mode of the estimated trajectory content CTp is changed when both the estimated trajectory content CTp and the route guidance content CTgs are displayed. According to the above, the similar effects to those of the first embodiment are achieved, and the user can easily distinguish the individual contents CTp and CTgs. Therefore, it is possible to display a plurality of contents in an easy-to-understand manner.

In addition, in the fifth embodiment, the intermediate portion of the estimated trajectory content CTp is locally hidden so as not to overlap with the route guidance content CTgs. As described above, since the shapes of the contents CTp and CTgs are controlled so as not to overlap each other, the ease of distinction by the user can be further ensured. As a result, more convenient information presentation is realized.

### Sixth Embodiment

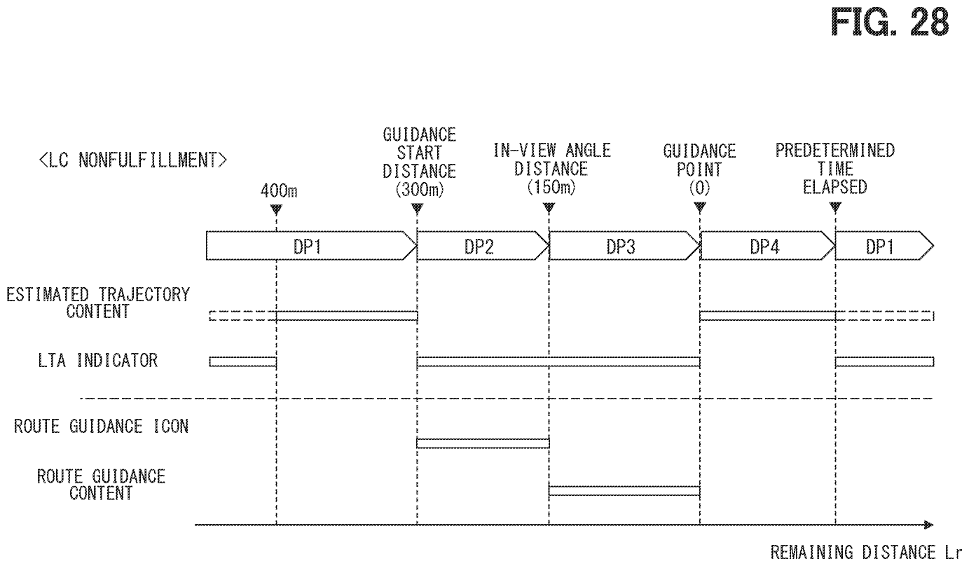

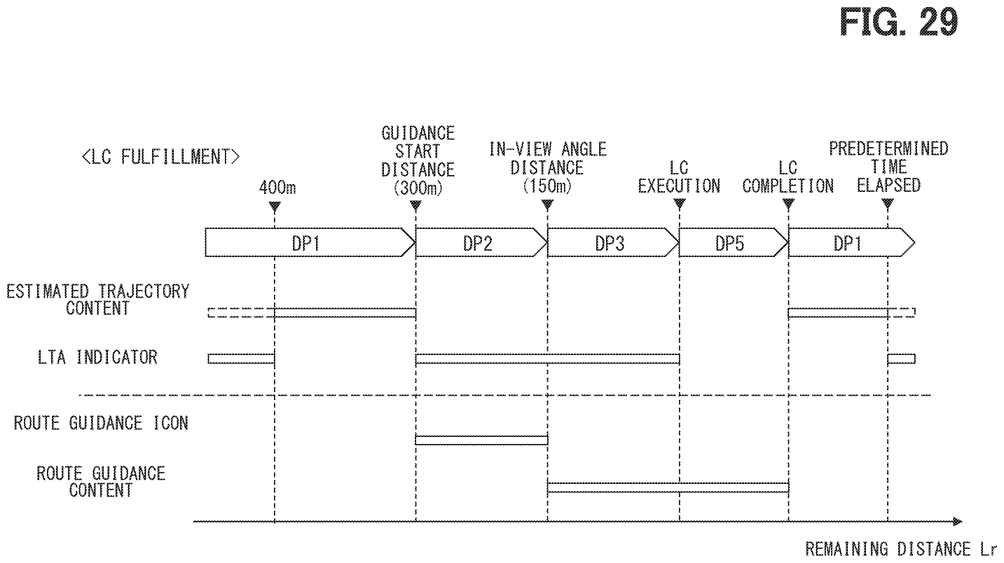

A sixth embodiment of the present disclosure illustrated in FIGS. 28 to 34 is still another modification of the first embodiment. In the sixth embodiment, the modes of the estimated trajectory content CTp and the route guidance content CTgs are different from those in the first embodiment. In addition, in each of displays DP1 to DP5 of the sixth embodiment, only one of an estimated trajectory content CTp, a route guidance icon CTgn, and a route guidance content CTgs is displayed in the angle of view VA (see FIGS. 28 and 29). Hereinafter, the details of each display in the sixth embodiment will be described in order.

The estimated trajectory display DP1 includes a single-line estimated trajectory content CTp displayed in the center of the subject vehicle lane Lns, as in the second embodiment (see FIG. 16). The estimated trajectory content CTp is not constantly displayed, unlike the second embodiment. The display generation unit 76 switches between displaying and hiding the estimated trajectory content CTp in a predetermined cycle during the period in which the lane keeping control is in the execution state. The display time of the estimated trajectory content CTp is shorter than the hidden time. When the guidance fulfillment request is acquired by the guidance information acquisition unit 72, the display generation unit 76 constantly displays the estimated trajectory content CTp at a point that is before the point at which the remaining distance Lr becomes the guidance start distance (for example, at a point of about the guidance start distance+100 m).

Also in the sixth embodiment, the display of an LTA indicator Itc (see FIG. 7) by the meter display 23 is carried out. The display generation unit 76 constantly displays the LTA indicator Itc during the period in which the displaying and hiding of the estimated trajectory content CTp are repeated. When the display generation unit 76 switches the estimated trajectory content CTp to the constant display, the display of the LTA indicator Itc is interrupted.

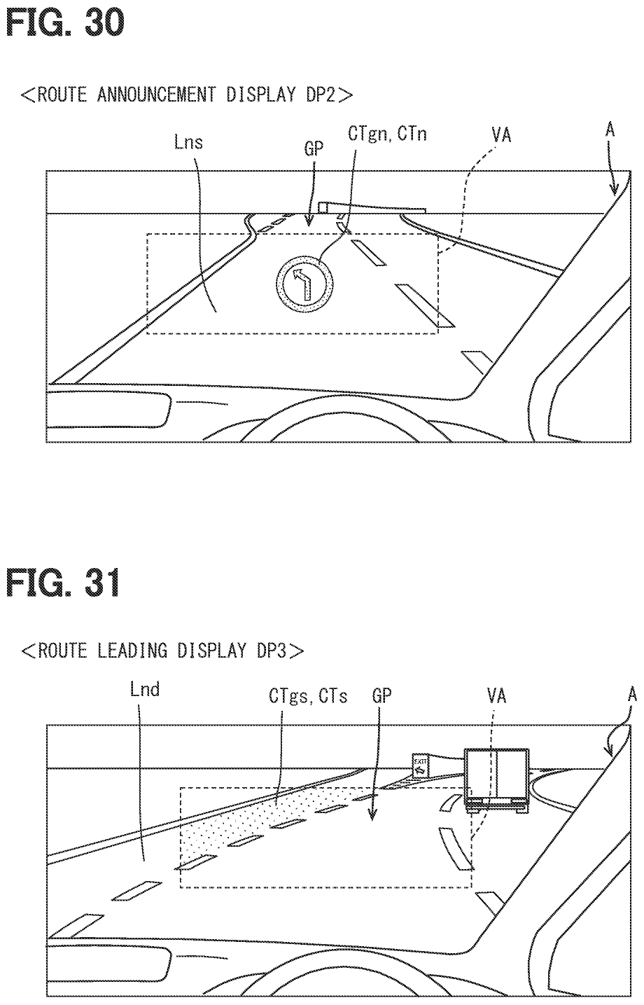

When the remaining distance Lr to the guidance point GP becomes less than the guidance start distance during the execution of the estimated trajectory display DP1 (FIG. 14, S104: YES), the display transition from the estimated trajectory display DP1 to the route announcement display DP2 is executed. In the route announcement display DP2, as shown in FIG. 30, the estimated trajectory content CTp is hidden, and the route guidance icon CTgn is displayed in place of the estimated trajectory content CTp. At this time, the display of the LTA indicator Itc by the meter display 23 is restarted.

When the remaining distance Lr is less than the in-view angle distance during the presentation of the route announcement display DP2 (FIG. 14, S106: YES), the display transition from the route announcement display DP2 to the route leading display DP3 is performed. In the route leading display DP3, as shown in FIG. 31, the route guidance icon CTgn is hidden, and the route guidance content CTgs is displayed in place of the route guidance icon CTgn. The route guidance content CTgs is displayed so as to fill the entire range included in the angle of view VA on the road surface of the guidance destination lane Lnd. The route guidance content CTgs is displayed in a mode related to the route guidance icon CTgn. As an example, the display color of the route guidance content CTgs is substantially the same as the route guidance icon CTgn.

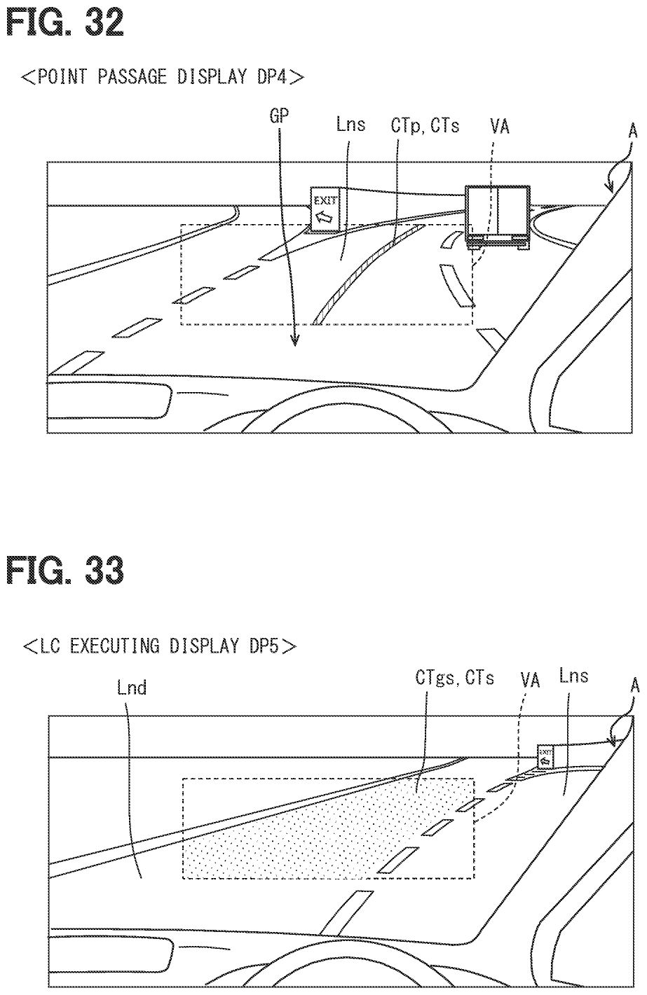

When the subject vehicle A passes the guidance point GP while the route leading display DP3 is being presented (FIG. 14, S108: YES), the display transition from the route leading display DP3 to the point passage display DP4 is performed. In the point passage display DP4, as shown in FIG. 32, the route guidance content CTgs is hidden, and the estimated trajectory content CTp is displayed in place of the route guidance content CTgs. Also in the point passage display DP4, the estimated trajectory content CTp is displayed to be superimposed on the road surface in the central portion of the subject vehicle lane Lns, as in the estimated trajectory display DP1. The display generation unit 76 interrupts the display of the LTA indicator Itc by the meter display 23 in accordance with the resumption of the display of the estimated trajectory content CTp.

Then, when a predetermined time elapses or the vehicle A travels a predetermined distance after passing the guidance point GP, a display transition from the point passage display DP4 to the estimated trajectory display DP1 is executed. As a result, the displaying and the hiding of the estimated trajectory content CTp are repeated at a predetermined cycle. The display generation unit 76 restarts the display of the LTA indicator Itc by the meter display 23 in accordance with the display transition to the estimated trajectory display DP1.

On the other hand, when the lane change is executed before passing through the guidance point GP (FIG. 14, S121: YES), the display transition from the route leading display DP3 to the LC execution display DP5 is executed. In the LC execution display DP5, as shown in FIG. 33, the display of the route guidance content CTgs is continued. The drawing shape of the route guidance content CTgs is sequentially updated according to the road surface shape of the guidance destination lane Lnd that overlaps with the angle of view VA. Further, the display of the LTA indicator Itc by the meter display 23 is interrupted in accordance with the display transition to the LC execution display DP5.

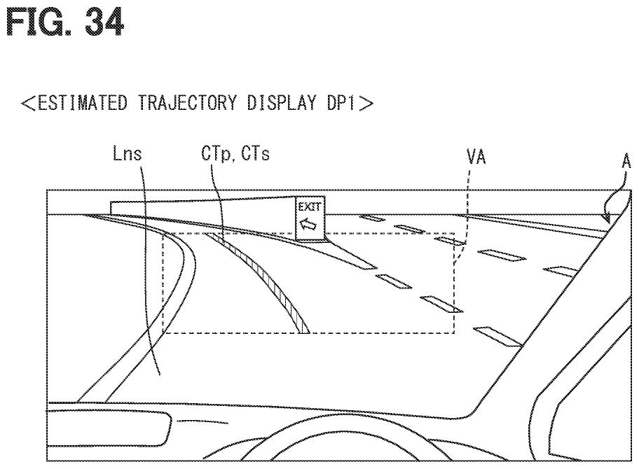

When the lane change to the guidance destination lane Lnd of the subject vehicle A is completed, the display transition to the estimated trajectory display DP1 shown in FIG. 34 is carried out. In the estimated trajectory display DP1 after the lane change, the route guidance content CTgs is hidden, and the estimated trajectory content CTp is displayed in place of the route guidance content CTgs. The display of the estimated trajectory content CTp is continued until a predetermined time elapses after the lane change or until the vehicle A travels a predetermined distance. Then, when the predetermined time elapses after the lane change or when the vehicle A travels a predetermined distance, the repetition of the displaying and the hiding of the estimated trajectory content CTp is started. At this time, the display of the LTA indicator Itc is restarted.

Also in the sixth embodiment described so far, the estimated trajectory content CTp is hidden when the route guidance content CTgs is displayed based on the acquisition of the guidance implementation request. In this way, since the simultaneous display of a plurality of contents is avoided, information presentation that is easy for the driver to understand is realized.

In addition, in the sixth embodiment, only one content related to the route guidance and the LTA function is displayed in the angle of view VA during the route guidance fulfillment period. According to the display logic that displays only one content that is highly needed in this way, the comprehensibility by the driver is further improved.

In the estimated trajectory display DP1 of the sixth embodiment, the displaying and the hiding of the estimated trajectory content CTp are repeated at regular intervals. Accordingly, the estimated trajectory content CTp can be the superimposition content CTs that does not cause trouble to the driver, while keeping the function of notifying the driver of the status information of the lane keeping control.

Further, in the sixth embodiment, the content for notifying the status information of the LTA function moves from the angle of view VA to the meter display 23 in accordance with the start of the route guidance by the route guidance icon CTgn. According to the above, it is possible for the driver to easily understand the display in the angle of view VA and to recognize the information through the meter display 23. Therefore, the convenience for the driver can be further improved.

### Other Embodiments

Although the multiple embodiments of the present disclosure have been described hereinabove, the present disclosure is not construed as being limited to the above-described embodiments, and can employ various embodiments and combinations within a range that does not depart from the spirit of the present disclosure.

In the embodiment described above, the display transition from the route announcement display DP2 to the route leading display DP3 is started immediately after the acquisition of the leading fulfillment request or at a predetermined timing after the acquisition of the leading fulfillment request, based on the acquisition of the leading fulfillment request by the guidance information acquisition unit 72. At such a timing, the estimated arrival time to reach the guidance point GP can be used. The estimated arrival time is calculated based on the remaining distance Lr based on the position information of the subject vehicle A and the vehicle speed information of the subject vehicle A.

In a first modification of the embodiment described above, the display generation unit 76 starts a display transition from a route announcement display DP2 to a route leading display DP3 based on a simulation result of a display layout. More specifically, the display generation unit 76 determines whether or not the guidance point GP is within an superimposition range SA based on the simulation results of the display layout, in place of the determination whether or not the remaining distance Lr to the guidance point GP is less than the in-view angle distance (see FIG. 14, S106). As such, before the guidance point GP enters the superimposition range SA, the display generation unit 76 causes the route announcement display DP2 to be executed. On the other hand, after the guidance point GP enters the superimposition range SA, the display generation unit 76 causes the route leading display DP3 to be executed.

According to the first modification described above, when the guidance point GP is outside the angle of view VA of the HUD 20, the route guidance icon CTgn is displayed together with the estimated trajectory content CTp. Then, when the guidance point GP moves within the angle of view VA, the route guidance content CTgs including the guidance point GP as the superimposition target is displayed in a superimposition manner. As a result, the display generation unit 76 can switch from the route guidance icon CTgn to the route guidance content CTgs, in other words, switch from the non-superimposition content CTn to the superimposition content CTs at an appropriate timing.

Further, the display generation unit 76 can hide the estimated trajectory content CTp at the timing when the guidance point GP moves within the angle of view VA. Therefore, the timing at which the presentation of the estimated trajectory is interrupted can be appropriately controlled.

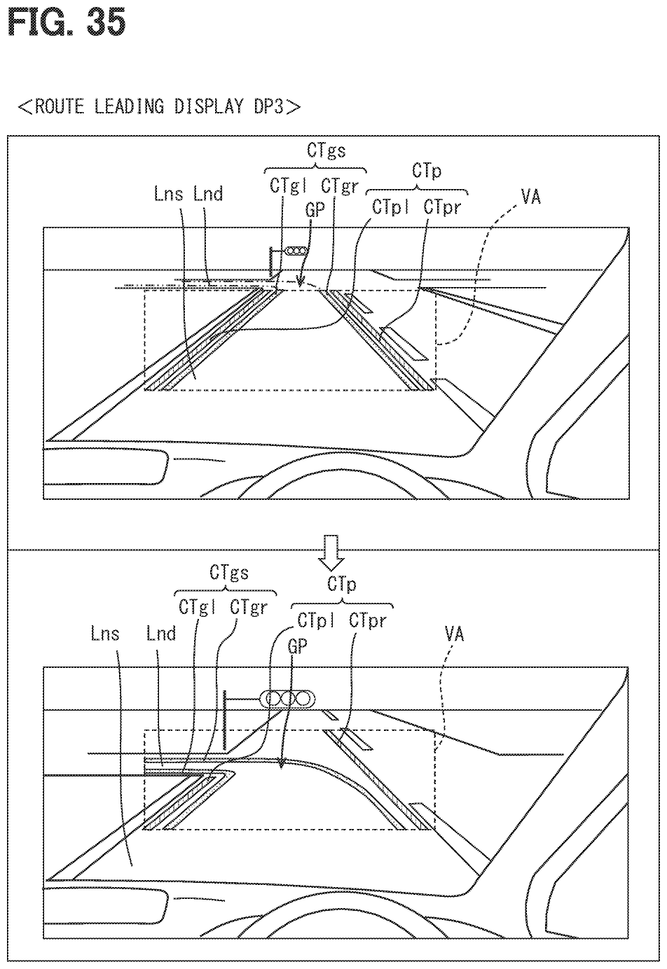

In a second modification shown in FIG. 35, as a modification of the third embodiment, the estimated trajectory content CTp includes boundary lines CTpl and CTpr. In a route leading display DP3 of the second modification, the boundary lines CTpl and CTpr are displayed on the left and right sides of the two guidance lines CTgl and CTgr, which are the route guidance contents CTgs, respectively.

Then, when the guidance point GP moves within the angle of view VA, the display range of the estimated trajectory content CTp is limited. More specifically, of the two boundary lines CTpl and CTpr, the display of the left boundary line CTpl close to the guidance destination lane Lnd is limited to the position on the near side to the vehicle A than the guidance point GP, that is, to a range not beyond the guidance point GP. As such, each of the guidance lines CTgl and CTgr extends from the subject vehicle lane Lns to the guidance destination lane Lnd without overlapping with the estimated trajectory content CTp. The right boundary line CTpr maintains an extended shape along the subject vehicle lane Lns without limiting the display range. Also in the second modification, it is possible to obtain the similar effects to those of the third embodiment.

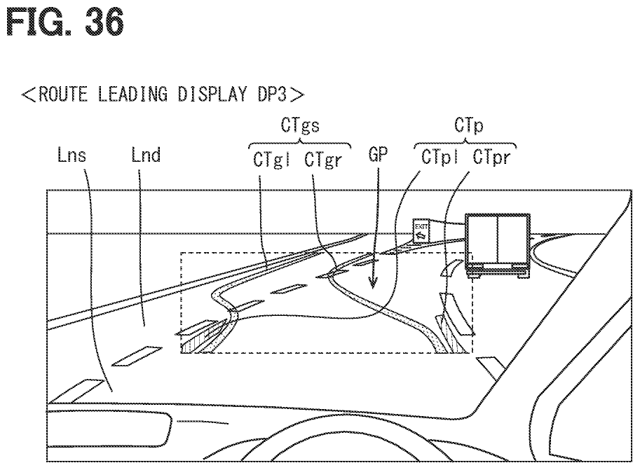

In a third modification shown in FIG. 36, as a modification of the third embodiment, the display range of both the two boundary lines CTpl and CTpr is limited. The display of each of the boundary lines CTpl and CTpr is limited to a range not beyond the branch point which is the guidance point GP. As such, the route guidance content CTgs composed of the guidance lines CTgl and CTgr has a shape extending from the subject vehicle lane Lns to the guidance destination lane Lnd without overlapping with the estimated trajectory content CTp. Even in the third modification, the guidance lines CTgl and CTgr and the boundary lines CTpl and CTpr may be displayed as animations that repeatedly extend from the subject vehicle side in the traveling direction.

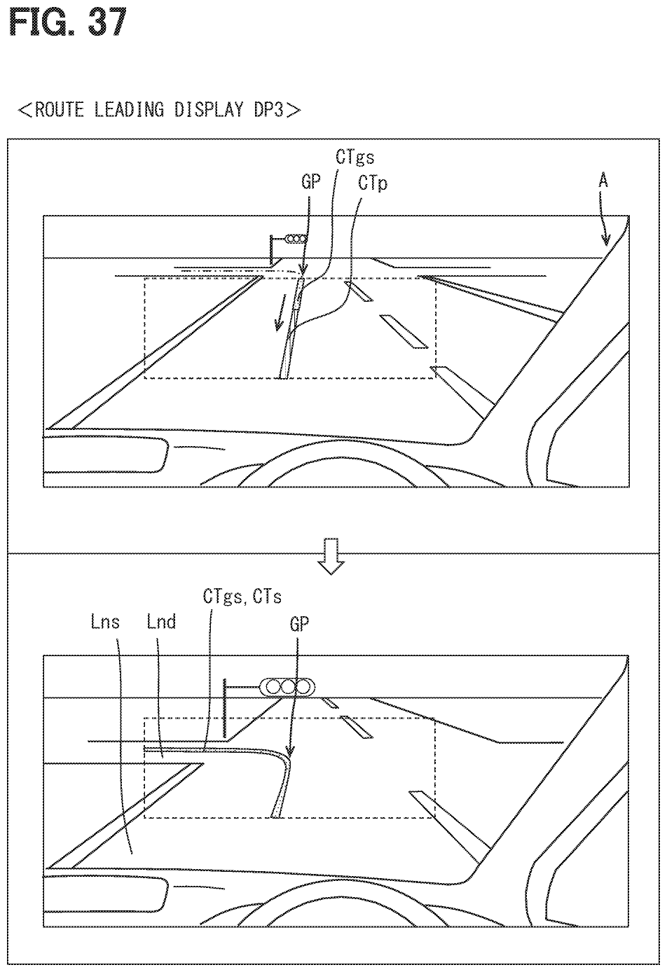

In a fourth modification shown in FIG. 37, as a modification of the fourth embodiment, each of the estimated trajectory content CTp and the route guidance content CTgs has a drawing shape of a single line. In a route leading display DP3 of the fourth modification, the route guidance content CTgs is overwritten with the estimated trajectory content CTp superimposed on the central portion of the subject vehicle lane Lns as the vehicle A approaches the guidance point GP. The route guidance content CTgs is replaced with the estimated trajectory content CTp by an animation extending from the guidance point GP side toward the subject vehicle side. As such, the route leading display DP3 has a display content specialized only for the route guidance at the guidance point GP by using the route leading content CTgs extending from the subject vehicle lane Lns to the guidance destination lane Lnd.

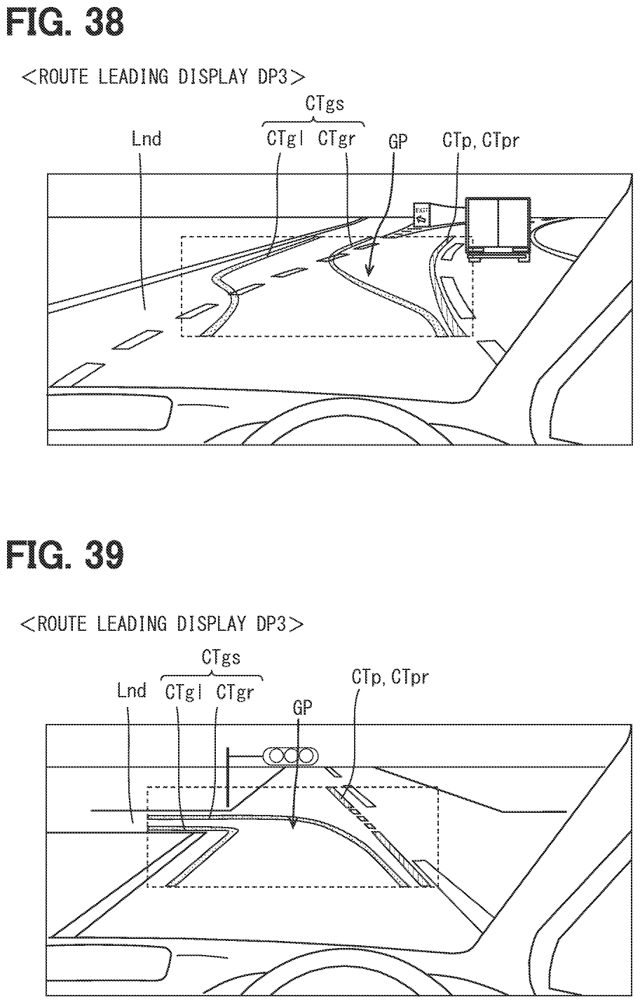

In a fifth modification shown in FIG. 38 and a sixth modification shown in FIG. 39, which are modifications of the fifth embodiment described above, in a route leading display DP3 at the guidance point GP, one boundary line on the side closer to the guidance destination lane Lnd is not hidden only at the intermediate portion, but is entirely hidden. As a result, in the route leading display DP3 of the fifth modification and the sixth modification, the route guidance content CTgs is emphasized rather than the estimated trajectory content CTp.

In the route leading display DP3 of the fifth modification shown in FIG. 38, when the lane change is made to the left at the branch point, the left boundary line is entirely hidden. On the other hand, the right boundary line CTpr continues to be displayed in the normal shape.

In the route leading display DP3 of the sixth modification shown in FIG. 39, when the vehicle A turns left at an intersection, the left boundary line is entirely hidden. In the sixth modification, the mode of the right boundary line CTpr is also changed. More specifically, in the sixth modification, an intermediate portion of the right boundary line CTpr superimposed on a range of the intersection is changed to a broken line shape. As such, in the estimated trajectory content CTp, the content of the specific mode change applied to the portion overlapping with the route guidance content CTgs may be changed as appropriate.

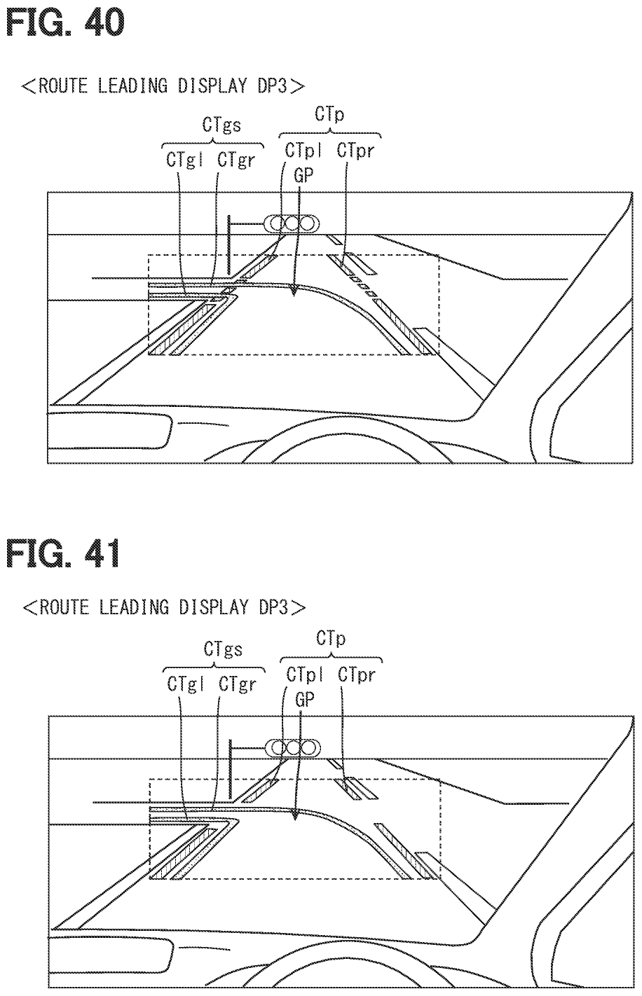

In a seventh modification shown in FIG. 40 and an eighth modification shown in FIG. 41, which are modifications of the fifth embodiment described above, the route leading display DP3 changes modes of both the left boundary line CTpl and the right boundary line CTpr. More specifically, in the seventh modification shown in FIG. 40, when the guidance point GP is an intersection, an intermediate portion of each of the boundary lines CTpl and CTpr superimposed on the intersection range is locally formed as a broken line. Therefore, even if one of the boundary lines (left boundary line CTpl) overlaps with each of the guidance lines CTgl and CTgr, the route guidance content CTgs is displayed more emphasized than the estimated trajectory content CTp. Further, in the eighth modification shown in FIG. 41, the intermediate portion of each of the boundary lines CTpl and CTpr superimposed on the intersection range is locally hidden. Therefore, the contents CTp and CTgs can maintain a state of being easily distinguished without overlapping each other.

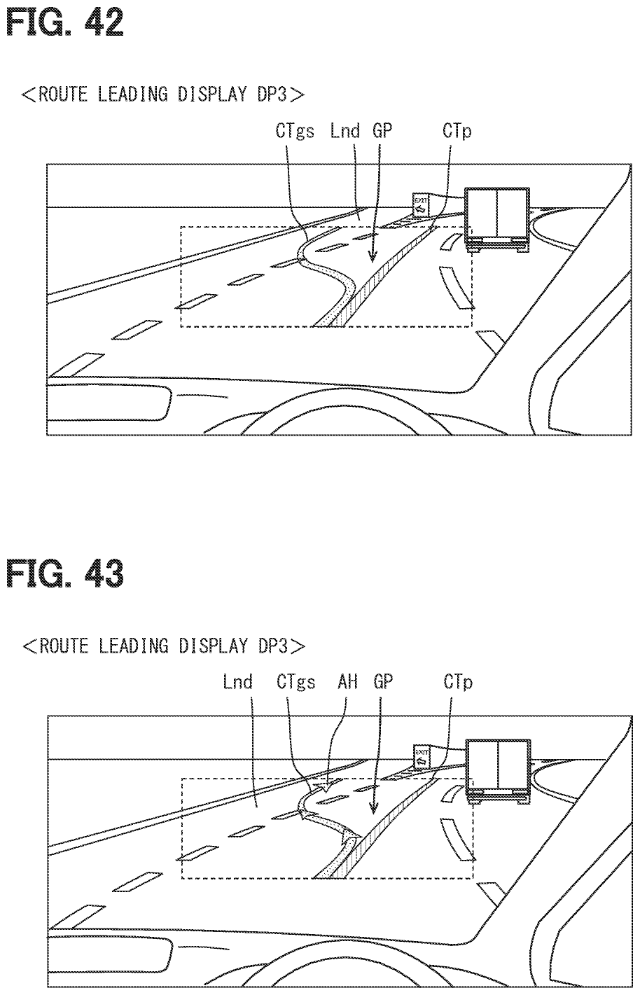

In a ninth modification shown in FIG. 42 and a tenth modification shown in FIG. 43, which are modifications of the first embodiment described above, each of the estimated trajectory content CTp and the route guidance content CTgs is drawn in a single line. In the route leading display DP3 at the guidance point GP, the route guidance content CTgs extends toward the guidance destination lane Lnd so as to branch off from the base end portion of the estimated trajectory content CTp. In the route leading display DP3, the expected trajectory content CTp and the route guidance content CTgs displayed together are in different modes from each other.

Specifically, the route guidance content CTgs of the ninth modification shown in FIG. 42 is displayed in a display color different from the estimated trajectory content CTp. In addition, the display brightness of the route guidance content CTgs is made higher than the estimated trajectory content CTp.

Further, a plurality of indicators AH indicating the direction of the guidance destination lane Lnd are added to the route guidance content CTgs of the tenth modification 10 shown in FIG. 43. Further, the route guidance content CTgs is displayed as an animation that repeatedly extends from the subject vehicle side toward the guidance destination lane Lnd.

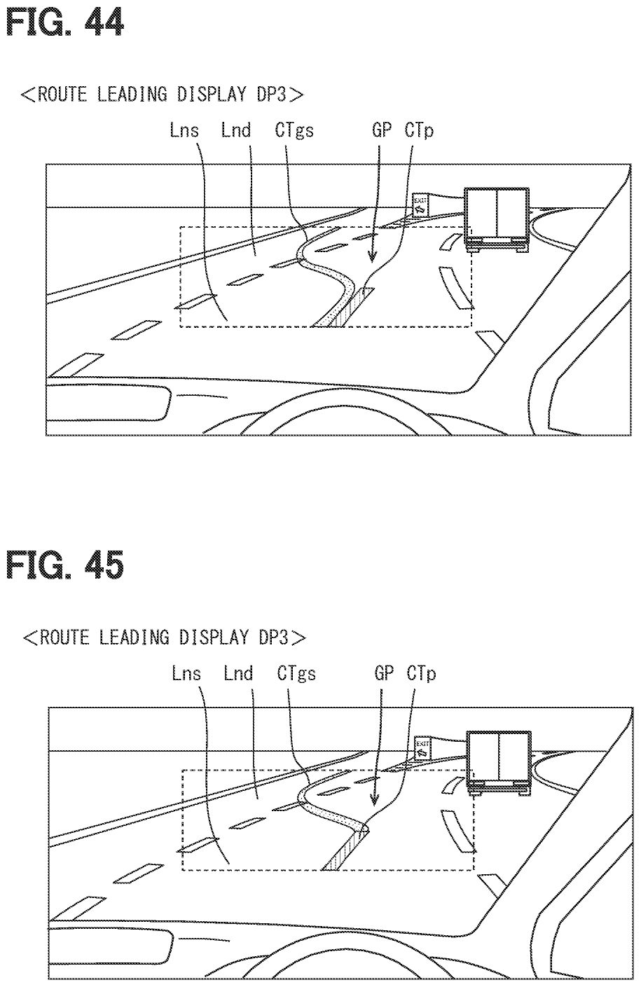

In an eleventh modification shown in FIG. 44 and a twelfth modification shown in FIG. 45, which are modifications of the third embodiment described above, each of the estimated trajectory content CTp and the route guidance content CTgs is drawn in a single line. In the route leading display DP3 at the guidance point GP, the route guidance content CTgs has a shape extending from the central portion of the subject vehicle lane Lns toward the guidance destination lane Lnd. On the other hand, the estimated trajectory content CTp exhibits a short band shape in which the display range is limited to a range not beyond the branch section including the guidance point GP. In the eleventh modification shown in FIG. 44, the estimated trajectory content CTp is arranged side by side on the side of the base end portion of the route guidance content CTgs. In the twelfth modification shown in FIG. 45, the estimated trajectory content CTp is displayed to be superimposed on the base end portion of the route guidance content CTgs.

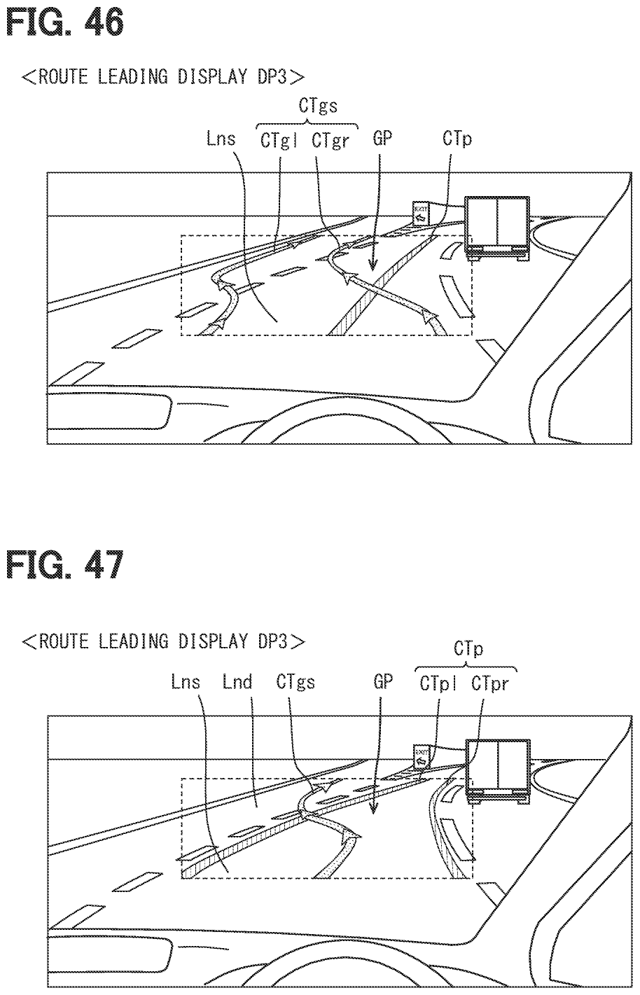

In a thirteenth modification shown in FIG. 46, which is a modification of the first embodiment described above, the estimated trajectory content CTp of the route leading display DP3 is drawn in a single line. On the other hand, the route guidance content CTgs is drawn in a double line including the guidance lines CTgl and CTgr. The right guidance line CTgr extends so as to cross the subject vehicle lane Lns at the guidance point GP, and is apparently superimposed on the estimated trajectory content CTp. The route guidance content CTgs is displayed as an animation that repeatedly extends from the subject vehicle side in the traveling direction.

In a fourteenth modification shown in FIG. 47, which is a modification of the first embodiment, the estimated trajectory content CTp is drawn in a double line including the boundary lines CTpl and CTpr in the route leading display DP3. On the other hand, the route guidance content CTgs is drawn in a single line. The route guidance content CTgs extends from the central portion of the subject vehicle lane Lns toward the guidance destination lane Lnd, and apparently overlaps the left boundary line CTpl. The route guidance content CTgs is displayed as an animation that repeatedly extends from the subject vehicle side in the traveling direction.

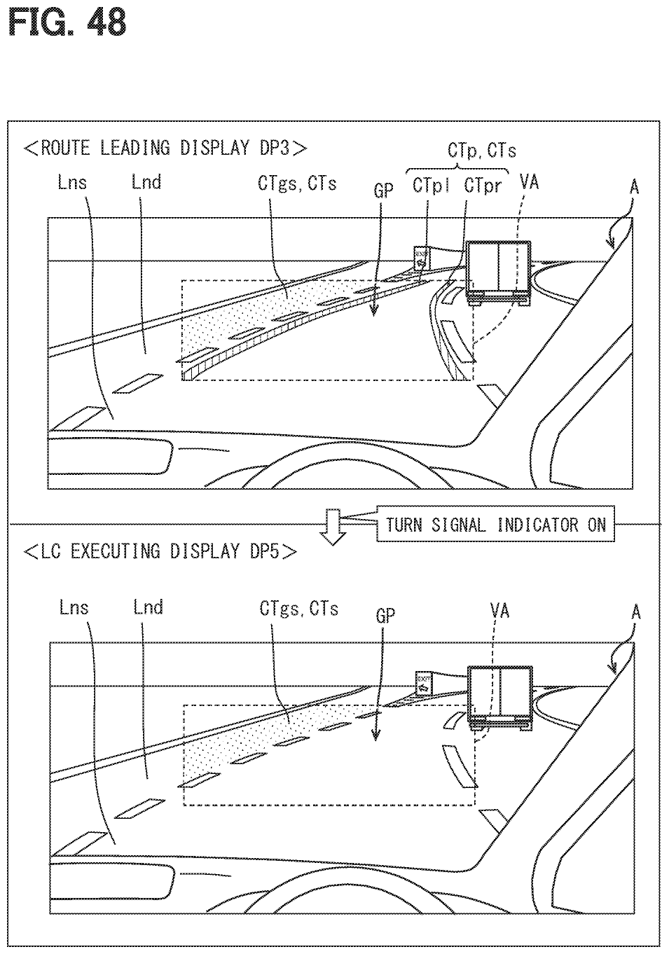

In a fifteenth modification shown in FIG. 48, which is a modification of the first embodiment described above, both the route guidance content CTgs and the estimated trajectory content CTp are displayed in the route leading display DP3. The route guidance content CTgs is the superimposition content CTs displayed so as to fill the road surface of the guidance destination lane Lnd, as in the sixth embodiment. On the other hand, the estimated trajectory content CTp is the superimposition content CTs including the left boundary line CTpl and the right boundary line CTpr, and is displayed to be superimposed on the road surface of the subject vehicle lane Lns. The estimated trajectory content CTp is hidden when the display is transitioned from the route leading display DP3 to the LC execution display DP5 based on the on operation of the turn signal switch by the driver or the like.

Even in the form of displaying the plurality of superimposition contents CTs at the same time as in the fifteenth modification, when the road surface ranges as the superimposition target to be superimposed are different, the overlapping of the contents is avoided. As a result, even if the estimated trajectory content CTp and the route guidance content CTgs are displayed simultaneously, the driver can easily distinguish and recognize each content.

In addition, in the fifteenth modification, the estimated trajectory content CTp is hidden at the timing when the lane change is started. As such, according to the display transition that appropriately reduces the content in the angle of view VA, it is possible to realize the presentation of information in an easy-to-understand manner.

In the fourth embodiment described above, the estimated trajectory content CTp is hidden in a form of being overwritten by the route guidance content CTgs after the display of the route guidance content CTgs is started. However, in a sixteenth modification as a modification of the above described embodiment, the guidance lines CTgl and CTgr are inserted at positions deviated from the boundary lines CTpl and CTpr in the route guidance content CTgs. As such, immediately after the transition from the route announcement display DP2 to the route leading display DP3, a state in which the entire route guidance content CTgs and the estimated trajectory content CTp are displayed is temporarily formed. Then, the estimated trajectory content CTp is hidden after the display of the route guidance content CTgs is completed. As described above, the timing for hiding the estimated trajectory content CTp may be after at least a part of the route guidance content CTgs is displayed, or after the entire route guidance content CTgs is displayed.

In the first and fifth embodiments described above, the estimated trajectory content CTp and the route guidance content CTgs are displayed to be superimposed on the road surface in different modes. The estimated trajectory content CTp and the route guidance content CTgs need only be different so that at least one of static elements such as display color, display brightness, and reference display shape can be distinguished by a driver. For example, the route guidance content CTgs may be drawn in a double line shape as in the first embodiment, while the estimated trajectory content CTp may have a drawing shape that fills the entire travel lane.

Further, the estimated trajectory content CTp and the route guidance content CTgs may differ from each other to the extent that at least one of the dynamic elements such as the presence/absence of blinking, the cycle of blinking, the presence/absence of animation, and the operation of animation can be distinguished by the driver. As such, when at least one of the static or dynamic elements is different, the estimated trajectory content CTp and the route guidance content CTgs are considered to be in different modes from each other.

In the embodiments and modifications described above, the driving scene in which the information presentation is illustrated is an example. The HCU can present information in combination with non-superimposition content and superposed content in a driving scene different from the example described above. Further, the shape, display position, display color, display brightness, presence or absence of animation, and the like of each content may be changed as appropriate, and may be changed according to, for example, the preference of a driver.

In the embodiment described above, the display of the estimated trajectory content CTp is limited to a range not beyond the guidance point GP as a predetermined point. However, the predetermined point that serves as a reference for limiting the display range may be appropriately changed based on, for example, the coordinate information of the intersection, the branch section, and the confluence section in the navigation map data and the high-precision map data. For example, an entrance node or an exit node of such as an intersection or a branch section may be set as a predetermined point.

In the embodiment described above, the display is transitioned from the estimated trajectory display DP1 to the route announcement display DP2 at the timing when the guidance point GP is outside the angle of view VA. However, in a seventeenth modification, as a modification of the embodiment described above, the route announcement display DP2 is omitted. In the seventeenth modification, the display generation unit transitions the display from the estimated trajectory display DP1 to the route leading display DP3 at the timing when the leading fulfillment request is acquired or when the guidance point GP is within the angle of view VA.

In the HCU of the embodiments described above, the projection shape and projection position of the virtual image light for forming the superimposition content are sequentially controlled using the position information of the eye point detected by the DSM so that the superimposition content is superimposed on the superimposed object without deviation when viewed from the driver. Alternatively, in a fourteenth modification as a modification the embodiments described above, the HCU controls the projection shape and projection position of the virtual image light for forming the superimposition content, without using the detection information of the DSM, but using the setting information of the center of the reference eye point set in advance.

As a nineteenth modification, the projector 21 of the HUD 20 is provided with an electro luminescence (EL) panel, in place of the LCD panel and the backlight. Further, in place of the EL panel, the HUD 20 may employ a projector using a display such as a plasma display panel, a cathode ray tube and an LED, in place of the EL panel.

As a twentieth modification, the HUD 20 is provided with a laser module (hereinafter referred to as LSM) and a screen, in place of the LCD and the backlight. The LSM includes, for example, a laser light source, a micro electro mechanical systems (MEMS) scanner, and the like. The screen is, for example, a micromirror array or a microlens array. In such a HUD 20, a display image is drawn on the screen by scanning the laser beam emitted from the LSM. The HUD 20 projects the display image drawn on the screen onto a windshield by the magnifying optical element, and displays the virtual image Vi in the air.

As a twenty-first modification, the HUD 20 is provided with a DLP (Digital Light Processing, registered trademark) projector. The DLP projector has a digital mirror device (hereinafter referred to as DMD) provided with a large number of micromirrors, and a projection light source that projects light toward the DMD. The DLP projector draws a display image on the screen under the control of linking the DMD and the projection light source.

As a twenty-second modification, the HUD 20 is provided with a projector using LCOS (Liquid Crystal On Silicon). Furthermore, as a twenty-third modification, the HUD employs a holographic optical element as one of the optical systems for displaying a virtual image in the air.

In a twenty-fourth modification, as a modification of the embodiment described above, only one of the driving assistance ECU 50 and the automatic driving ECU 52 is mounted on the vehicle A. As described above, a plurality of lane keeping control units may not be provided on the in-vehicle system side. In a twenty-fifth modification as a modification of the embodiment described above, the driving assistance ECU 50 and the automatic driving ECU 52 are mounted on the vehicle A as one in-vehicle ECU.

In a twenty-sixth modification, as a modification of the embodiment described above, the HCU 100 is provided with a camera image acquisition unit that acquires the imaged data obtained by capturing the foreground of the subject vehicle, which is the imaged data of the front camera 31. The display generation unit 76 generates video data obtained by superimposing an original image such as an estimated trajectory content CTp, a route guidance icon CTgn, and a route guidance content CTgs on a real image of the foreground based on the captured data. Based on such video data, the HUD 20 projects a display in which each content and an icon are superimposed on a real image as a virtual image in the foreground. When the angle of view of the HUD 20 is not sufficient as in the twenty-sixth modification, a virtual image display in which the original image such as the content used for the AR display is superimposed on the real image may be displayed in a scene where the AR content deviates from the angle of view VA,

In a twenty-seventh modification, as a modification of the embodiment described above, the HCU 100 and the HUD 20 are integrally configured. That is, the processing function of the HCU is mounted on the control circuit of the HUD. In such a twenty-seventh modification, the HUD corresponds to the “display control device”. Further, the processing function of the HCU may be mounted on the meter ECU, the navigation ECU and the display audio ECU. In such modifications, the meter device, the navigation device, and the display audio device correspond to the “display control device”.

In the embodiments described above, the respective functions provided by the HCU can be also provided by software and hardware for executing the software, only software, only hardware, and complex combinations of software and hardware. In cases where these functions are provided by electronic circuits as hardware, the respective functions can be also provided by analog circuits or digital circuits which include a large number of logic circuits.

Further, the specific implementation of the storage medium for storing the program or the like capable of executing the above-described display control method may be changed as appropriate. For example, the storage medium is not limited to the configuration provided on the circuit board, and may be provided in the form of a memory card or the like. The storage medium may be inserted into a slot portion, and electrically connected to the control circuit of the HCU. The storage medium may include an optical disk which forms a source of programs to be copied into a HCU, a hard disk drive therefor, and the like.

The vehicle equipped with the HMI system is not limited to a general private car, but may be a rented vehicle, a vehicle for man-driving taxi, a vehicle for sharing vehicle service, a freight vehicle, a bus, or the like. Further, the HMI system including the HCU may be mounted on a driverless vehicle used for a mobility service.

The vehicle equipped with the HMI system may be a right-hand drive vehicle or a left-hand drive vehicle. Further, the traffic environment in which the vehicle travels may be a traffic environment premised on left-hand traffic, or may be a traffic environment premised on right-hand traffic. The lane keeping control and its related display according to the present disclosure are appropriately optimized according to the road traffic law of each country and region, the steering wheel position of the vehicle, and the like.

The control unit and the method thereof which have been described in the present disclosure may be also implemented by a special purpose computer which includes a processor programmed to execute one or more functions implemented by computer programs. Alternatively, the device and the method described in the present disclosure may be implemented by a special purpose hardware logic circuit. Also, the device and the method described in the present disclosure may be also realized by one or more dedicated computers which are constituted by combinations of a processor for executing computer programs and one or more hardware logic circuits. The computer programs may be stored, as instructions to be executed by a computer, in a tangible non-transitory computer-readable medium.

What is claimed is:

1. A display control device for a vehicle to control a display on a head-up display, the display control device comprising:
a boundary information acquisition unit that acquires boundary information regarding a boundary of a travel lane recognized for a driving control of the vehicle;
a guidance information acquisition unit that acquires guidance information used for a route guidance; and
a display control unit that displays an estimated trajectory content indicating an estimated trajectory of the vehicle, a driving of which is controlled based on the boundary information, to be superimposed on a road surface, and displays a route guidance content providing guidance on a route at a predetermined point based on the guidance information, wherein
the display control unit displays the estimated trajectory content and the route guidance content in different modes from each other, when displaying the estimated trajectory content and the route guidance content together.

2. The display control device according to claim 1, wherein
the display control unit changes the mode of a portion of the estimated trajectory content, the portion overlapping with the route guidance content.

3. The display control device according to claim 1, wherein
when a distance to the predetermined point is equal to or greater than a specific distance, the display control unit displays the route guidance content as a non-superimposition content that is independent of a specific position on the road surface as a superimposition target, together with the estimated trajectory content, and
when the distance to the predetermined point is less than the specific distance, the display control unit superimposedly displays the route guidance content as a superimposition content containing the road surface of the predetermined point as the superimposition target.

4. The display control device according to claim 1, wherein
when the predetermined point is outside an angle of view of the head-up display, the display control unit displays the route guidance content as a non-superimposition content that is independent of a specific position on the road surface as a superimposition target, together with the estimated trajectory content, and
when the predetermined point enters the angle of view, the display control unit superimposedly displays the route guidance content as a superimposition content containing the road surface of the predetermined point as the superimposition target.

5. The display control device according to claim 1, wherein
the display control unit hides the estimated trajectory content, when a specific driving operation by a driver is input.

6. A display control device for a vehicle to control a display on a head-up display, the display control device comprising:
a boundary information acquisition unit that acquires boundary information regarding a boundary of a travel lane recognized for a driving control of the vehicle;
a guidance information acquisition unit that acquires guidance information used for a route guidance, and
a display control unit that displays an estimated trajectory content indicating an estimated trajectory of the vehicle, a driving of which is controlled based on the boundary information, to be superimposed on a road surface, and displays a route guidance content providing guidance on a route at a predetermined point based on the guidance information, wherein
the display control unit limits a display range of the estimated trajectory content to a range not beyond the predetermined position, when displaying the estimated trajectory content and the route guidance content together.

7. The display control device according to claim 1, wherein
when a distance to the predetermined point is equal to or greater than a specific distance, the display control unit displays the route guidance content as a non-superimposition content that is independent of a specific position on the road surface as a superimposition target, together with the estimated trajectory content, and
when the distance to the predetermined point is less than the specific distance, the display control unit superimposedly displays the route guidance content as a superimposition content containing the road surface of the predetermined point as the superimposition target.

8. The display control device according to claim 1, wherein
when the predetermined point is outside an angle of view of the head-up display, the display control unit displays the route guidance content as a non-superimposition content that is independent of a specific position on the road surface as a superimposition target, together with the estimated trajectory content, and
when the predetermined point enters the angle of view, the display control unit superimposedly displays the route guidance content as a superimposition content containing the road surface of the predetermined point as the superimposition target.

9. The display control device according to claim 1, wherein
the display control unit hides the estimated trajectory content, when a specific driving operation by a driver is input.

10. A display control device for a vehicle to control a display on a head-up display, the display control device comprising:
a boundary information acquisition unit that acquires boundary information regarding a boundary of a travel lane recognized for a driving control of the vehicle;
a guidance information acquisition unit that acquires guidance information used for a route guidance; and
a display control unit that displays an estimated trajectory content indicating an estimated trajectory of the vehicle, a driving of which is controlled based on the boundary information, to be superimposed on a road surface, and displays a route guidance content providing guidance on a route at a predetermined point based on the guidance information, wherein
the display control unit hides the estimated trajectory content and displays the route guidance content, when the guidance information is acquired during display of the estimated trajectory content.

11. The display control device according to claim 10, wherein
the display control unit hides the estimated trajectory content after displaying the route guidance content.

12. The display control device according to claim 10, wherein
the display control unit causes a display device different from the head-up display to continue presentation of the estimated trajectory content.

13. The display control device according to claim 10, wherein
when a distance to a predetermined point is equal to or greater than a specific distance, the display control unit displays the route guidance content as a non-superimposition content that is independent of the road surface as a superimposition target, together with the estimated trajectory content, and
when the distance to the predetermined point is less than the specific distance, the display control unit displays the route guidance content as a superimposition content to be superimposed on the road surface as a superimposition target, and hides the estimated trajectory content.

14. The display control device according to claim 10, wherein
when the predetermined point is outside an angle of view of the head-up display, the display control unit displays the route guidance content as a non-superimposition content that is independent of the road surface as a superimposition target, together with the estimated trajectory content, and
when the predetermined point enters the angle of view, the display control unit displays the route guidance content as a superimposition content to be superimposed on the road surface as a superimposition target, and hides the estimated trajectory content.

15. A non-transitory computer-readable storage medium which stores program instructions for controlling a head-up display of a vehicle, the program instructions configured to cause one or more processors to:
acquire boundary information regarding a boundary of a lane recognized for a driving control of the vehicle;
display an estimated trajectory content indicating an estimated trajectory of the vehicle, a driving of which is controlled, to be superimposed on a road surface based on the boundary information;
acquire guidance information used for a route guidance; and
display a route guidance content providing guidance on a route at a predetermined point based on the guidance information, wherein
the program instructions are configured to further cause the one or more processors to display the estimated trajectory content and the route guidance content in different modes from each other, when displaying the estimated trajectory content and the route guidance content together.

16. A non-transitory computer-readable storage medium which stores program instructions for controlling a head-up display of a vehicle, the program instructions configured to cause one or more processors to:
acquire boundary information regarding a boundary of a lane recognized for a driving control of the vehicle;
display an estimated trajectory content indicating an estimated trajectory of the vehicle, a driving of which is controlled, to be superimposed on a road surface based on the boundary information;
acquire guidance information used for a route guidance; and
display a route guidance content providing guidance on a route at a predetermined point based on the guidance information, wherein
the program instructions are configured to further cause the one or more processors to limit a display range of the estimated trajectory content to a range not beyond the predetermined point, when displaying the estimated trajectory content and the route guidance content together.

17. A non-transitory computer-readable storage medium which stores program instructions for controlling a head-up display of a vehicle, the program instructions configured to cause one or more processors to:
acquire boundary information regarding a boundary of a lane recognized for a driving control of the vehicle;
display an estimated trajectory content indicating an estimated trajectory of the vehicle, a driving of which is controlled, to be superimposed on a road surface based on the boundary information; and
display a route guidance content providing guidance on a route at a predetermined point based on the guidance information while hiding the estimated trajectory content, when guidance information used for a route guidance is acquired during display of the estimated trajectory content.
